(19) United States
(12) Patent Application Publication
(10) Pub. No.: US 2007/0292958 A1
(43) Pub. Date: Dec. 20, 2007

(54) Apparatuses and methods for monitoring enzymatic reactions

(75) Inventors: William R. Lacourse, Catonsville, MD (US); Swati J. Modi, Morrisville, NC (US)

Correspondence Address: STERNE, KESSLER, GOLDSTEIN & FOX P.L.L.C., 1100 NEW YORK AVENUE, N.W., WASHINGTON, DC, 20005, US

(73) Assignee: University of Maryland, Baltimore County, Baltimore, MD (US)

(21) Appl. No.: 11/708,047

(22) Filed: Feb. 20, 2007

Related U.S. Application Data
(60) Provisional application No. 60/774,531, filed on Feb. 20, 2006.
(60) Provisional application No. 60/788,305, filed on Mar. 31, 2006.
(60) Provisional application No. 60/790,145, filed on Apr. 7, 2006.
(60) Provisional application No. 60/794,621, filed on Apr. 25, 2006.

(51) Int. Cl. G01N 35/10; G01N 30/00

(52) U.S. Cl. 436/34; 436/43

(57) ABSTRACT

The present invention relates to apparatuses and methods for analyzing enzyme reactions, including, large, industrial-scale reactions. The methods allow for enzymatic reaction to be followed on-line in real-time, without the need for sample removal and without contamination. Furthermore, the methods provide for quantitative analysis of analytes of enzymatic reactions.

### CROSS REFERENCE TO RELATED APPLICATIONS

This application claims priority to U.S. Provisional Patent Application No. 60/774,531, filed Feb. 20, 2006; 60/788,305, filed Mar. 31, 2006; 60/790,145, filed Apr. 7, 2006; and 60/794,621, filed Apr. 25, 2006; the disclosures of each of which are incorporated by reference herein in their entireties.

### STATEMENT REGARDING FEDERALLY SPONSORED RESEARCH

Portions of this invention may have been made with United States Government support under a Chemistry-Biology Interface Training Grant from the National Institutes of Health, Grant No. T32 GM066706. As such, the U.S. Government may have certain rights in this invention.

### BACKGROUND OF THE INVENTION

1. Field of the Invention

The present invention relates to apparatuses and methods for analyzing enzyme reactions, including, large, industrial-scale reactions. The methods allow for enzymatic reaction to be followed on-line, in real-time, without the need for sample removal and without contamination. Furthermore, the methods provide for quantitative analysis of analytes of enzymatic reactions.

2. Background of the Invention

Enzymes are the reaction catalysts of biological systems. They have extraordinary catalytic power, often a high degree of substrate specificity and can greatly accelerate specific chemical reactions. A. G. Marangoni, Enzyme Kinetics: A Modern Approach, Wiley-Interscience, Hoboken, N.J., 2003. Michaelis-Menten enzyme kinetic parameters such as Kₘ and Vₘₐₓ offer a basis of comparison of different substrates for the same enzyme, or even comparison of different enzymes. V. Leskovac, Comprehensive Enzyme Kinetics, Kluwer Academic/Plenum Publishers, New York, 2003. Current methods for determining Michaelis-Menten enzyme kinetic parameters most often involve direct or indirect spectrophotometric methods. K. Tipton, in R. Eisenthal, M. J. Danson (Editors), Enzyme Assays, A Practical Approach, IRL Press, Oxford, UK, 1995, p. 1; A. Wiseman, Enzyme Microb. Technol. 4:73 (1982). In cases where spectra of substrate and product are very similar however, direct spectrophotometric methods are difficult to carry out as the signals of both species are overlapping.

Enzymatic bioprocesses and fermentation broths are complex mixtures of nutrients, waste products, cells, cell debris, and analytes of interest. Sampling from the bioreactor often involves the removal of aliquots of fluid, quenching of the reaction, centrifugation, and dilution prior to separation and detection. This off-line sampling method is a time-consuming process that results in volume loss (which may affect the kinetics of the reactions inside the bioreactor) and possible contamination of the bioprocess.

Sampling methods such as microdialysis allow researchers to sample a reaction mixture continuously to obtain the complete kinetic profile. J. A. Stenken, et al., J. Pharm. Biomed. Anal. 8:85 (1990); N. Torto and L. Gordon, Trends Anal. Chem. 18:252 (1999). Additionally, microdialysis is easily coupled to high performance liquid chromatography (HPLC) apparatus, thereby allowing for the separation of substrate from product and the study of kinetics of various reactions individually by ultraviolet absorbance and other forms of detection. J. A. Stenken, et al., Anal. Chem. 65:2324 (1993). However, there have been few studies monitoring enzyme substrates and reactants in bioprocesses in vitro by using microdialysis sampling, and the technique has not been successfully expanded to on-line, real-time monitoring of industrial scale enzymatic processes in order to provide quantitative measures, as well as reaction kinetics.

Initial reports using on-line microdialysis sampling coupled to high performance anion-exchange chromatography (HPAEC) and pulsed electrochemical detection (PED) for carbohydrate analysis did not provide quantitative results, and simply demonstrated that a small-scale bioprocess (hydrolysis) could be monitored continuously for a period of 32 hours. Torto, N., et al., Analytica Chimica Acta 313:15-24 (1995). Similarly, while microdialysis sampling with HPAEC-PED has been used to provide quantitative monitoring of lactose hydrolysis in skim and whole milk, this reaction is representative of only a small-scale, laboratory-based experiment, and provided no indication that such methods could be expanded to large scale, industrial enzyme reactions. Zook, C. M. and LaCourse, W. R., Current Separations 17:41-45 1998.

In addition, while work has been performed in the area of fermentation monitoring using microdialysis, including E. coli fermentations (Palmisano, F., et al., Biosensors & Bioelectronics 11:419-425 (1996)), enzymatic hydrolysis of dissolving pulp and of sugar cane bagasse (Wu, Y., S. et al., Journal of Chromatography A 913:341-347 (2001)), and the carbohydrates present in legume seeds after enzymatic hydrolysis with endomannanase (Okatch, H., et al., Journal of Chromatography A 992:67-74 (2003)), quantitative data were not pursued in these experiments, and the actual concentrations of analytes present in the bioprocess were undetermined.

There is currently therefore a need for methods and apparatus for on-line, real-time quantitative determination of enzyme substrates and reactants in dynamic enzymatic bioprocesses, including for the monitoring of large-scale, industrial bioprocesses and reactions. The present invention fulfills these needs.

### SUMMARY OF THE INVENTION

In one embodiment, the present invention methods for on-line, real-time quantification of one or more analytes of an enzymatic reaction. One or more analytes of an enzymatic reaction in a reaction vessel are transferred to a volume of perfusate, wherein the analytes are at an initial concentration in the reaction vessel. The concentration of the one or more perfused analytes is then modulated to a quantifiable concentration, and then the perfused analytes are quantified, in real-time. In suitable embodiments, the transferring comprises microdialysis sampling.

Exemplary analytes include substrates and products of the enzymatic reactions, for example, carbohydrates and carbohydrate hydrolysis products.

The perfusate can be connected to the reaction vessel, or can be indirectly connected. Exemplary methods for modulating the concentration include flowing the perfusate at a measured flow rate, wherein the flow rate (e.g., between about 100 nL/min and about 50 μL/min) achieves a quantifiable concentration of the one or more perfused analytes. In addition, the modulating can further comprise diluting the one or more perfused analytes with a diluent. In other embodiments, the modulating comprises flowing the perfusate at a flow rate that is less than about 100 nL/min, and diluting the one or more perfused analytes with a diluent, wherein the flow rate and the diluting achieve a quantifiable concentration of the one or more perfused analytes. Suitably, an internal standard is introduced into the enzymatic reaction and/or the perfusate prior to the quantifying.

Suitably, quantifying of the analytes comprises separating the one or more analytes, followed by detecting the one or more analytes. Exemplary methods of separating include, but are not limited to, liquid chromatography, size exclusion chromatography and anion exchange chromatography. Exemplary methods of detection include, but are not limited to, ultraviolet absorption, fluorescence detection, mass spectrometry, refractive index detection or pulsed electrochemical detection. Suitably, the reaction vessel comprises greater than about one liter of the enzymatic reaction.

The present invention also provides methods for on-line, real-time quantification of one or more carbohydrate products and one or more carbohydrate hydrolysis substrates of an enzymatic reaction. Suitably, one or more carbohydrate substrates and one or more carbohydrate hydrolysis products in a reaction vessel are transferred into a perfusate with a microdialysis sampler, wherein the substrates and products are at an initial concentration in the reaction vessel. The concentration of the one or more perfused substrates and one or more perfused products is then modulated to a quantifiable concentration. The perfused substrates and the perfused products are then separated by anion exchange chromatography; and then detected, in real-time, by pulsed electrochemical detection.

The present invention also provides apparatuses for on-line, real-time quantification of one or more analytes of an enzymatic reaction. Such apparatuses suitably comprise a reaction vessel comprising greater than about one liter of the enzymatic reaction; a microdialysis sampler in fluid communication with the enzymatic reaction; a microdialysis sampler protective covering; a pump for regulating perfusate flow through the microdialysis sampler; a diluter; one or more separation devices; one or more detectors; and an automated controller.

Further embodiments, features, and advantages of the invention, as well as the structure and operation of the various embodiments of the invention are described in detail below with reference to accompanying drawings.

### BRIEF DESCRIPTION OF THE FIGURES

The invention is described with reference to the accompanying drawings. In the drawings, like reference numbers indicate identical or functionally similar elements.

FIG. 1 is a schematic of an apparatus for on-line, real-time quantification of enzymatic reactions in accordance with one embodiment of the present invention.

FIG. 2 is schematic of an exemplary microdialysis-HPAEC-PED set-up in accordance with one embodiment of the present invention.

FIG. 3 shows chromatograms from HPAEC-PED analysis of maltodextrin (25,000 ppm) by direct injection and following microdialysis clean-up with a 3 cm loop probe. Loop size 25 μL, perfusion flow rate 5 μL/min.

FIG. 4 shows overlapping chromatograms of 25,000 ppm maltodextrin microdialysates blank and in the presence of denatured and active Tide® sampled from 1 to 4 hours into the enzymatic reaction. Detergent concentration 1.5 mg/mL. Inset shows enlargement of 5 to 25 minute region.

FIG. 5 shows a chromatogram of dialysate from denatured Tide® solution containing 2000 ppm amylopectin (______) and the blank, water ( . . . ).

FIG. 6 shows microdialysis-HPAEC-PED monitoring of amylopectin (2000 ppm) digestion by Tide® laundry detergent enzymes using a 3 cm loop probe and perfusion flow rate of 5 μL/min.

FIG. 7 shows maltooligosaccharide separation on microbore HPAEC-PED system.

FIG. 8 shows MD-HPAEC-PED analysis of laundry detergent wash process containing 0.05% corn starch solution and 15 mg/L α-amylase from Bacillus licheniformis.

FIGS. 9A-9C show maltooligosaccharide concentration over time in Bacillus licheniformis (A), Bacillus sp. (B), and Bacillus amyloliquefaciens (C), α-amylase 0.05% corn starch solution laundry detergent process.

FIG. 10 shows comparison of amylases in 0.05% corn starch detergent processes.

FIG. 11A shows MD-HPAEC-PED analysis of EMPA 161 laundry detergent wash process containing eight 3″×3″ cloths/L and 15 mg/L α-amylase from Bacillus sp.

FIG. 11B shows a representation of changing maltooligosaccharide concentration overtime in Bacillus sp. α-amylase EMPA 161 cloth detergent process.

FIG. 12 shows a comparison of α-amylase activity in EMPA cloth detergent processes.

FIG. 13 shows a comparison of Bacillus licheniformis α-amylase activity in 0.05% corn starch solution (top left) and EMPA 161 process (bottom left) and Heinz Baby Food cloth detergent processes (bottom right).

FIG. 14 shows initial concentrations of M1-M7 in mash by MD sampling vs. direct injection of filtered/diluted supernatant.

FIG. 15 shows MD-HPAEC-PED of liquefied corn mash at t=0 hrs and 8 hrs.

FIG. 16 shows average maltooligosaccharide concentration over first eight hours of liquefied corn mash/glucoamylase enzymatic process from three separate experiments.

FIG. 17 shows concentration of M1-M7 over a 60 hour liquefied corn mash plus glucoamylase experiment monitored by on-line microdialysis-HPAEC-PED.

### DETAILED DESCRIPTION OF THE INVENTION

It should be appreciated that the particular implementations shown and described herein are examples of the invention and are not intended to otherwise limit the scope of the present invention in any way.

In one embodiment, the present invention provides methods for on-line, real-time quantification of one or more analytes of an enzymatic reaction. As discussed throughout, the methods of the present invention provide on-line, real-time monitoring of large-scale bioprocesses, including industrial enzymatic reactions.

As used herein the term “on-line” means that the various systems, apparatuses and controllers utilized in the methods described throughout are connected such that analytes are passed from the enzymatic reaction directly to these additional components without the need for external intervention (i.e., in an automated fashion). That is, the various components are connected such that the sample is analyzed after being removed from the enzymatic reaction in a continuous, or fairly continuous manner.

As used herein, the term “real-time” means that the quantification occurs while the enzymatic process is occurring, or has just finished reacting, such that the reaction can be followed in the various stages. Real-time quantification means that there is little or no delay between the removal of analytes from the reaction and the quantification, and that the analysis does not have to wait until the reaction has ended.

In exemplary embodiments, one or more analytes in an enzymatic reaction are transferred from a reaction vessel to a perfusate. As used herein, the term “reaction vessel” includes any container, drum, vat, or other receptacle, etc., in which an enzymatic reaction is occurring. The concentration(s) of the perfused analytes are then modulated to quantifiable concentrations. The perfused analytes are then quantified in real-time using various processes discussed throughout.

As discussed throughout, microdialysis is an exemplary method for transferring the one or more analytes from the enzymatic reaction to a perfusate. Microdialysis (MD) and the use of microdialysis probes/systems/apparatus involves the use of a semi-permeable membrane for sampling complex matrices including both in vitro and in vivo applications. A microdialysis membrane is placed in fluid communication with an enzymatic reaction such that analytes are able to pass through the membrane into a perfusate. Perfusate refers to the liquid flowing into the dialysis section of the apparatus/probe/system that is used to remove analytes from the sample.

As used herein, a microdialysis membrane that is “in fluid communication” with a sample, solution, enzymatic reaction, etc., means that the membrane is contacting the sample, solution, enzymatic reaction etc., such that analytes are able to diffuse through the membrane. The perfusate is passed on the side of the membrane opposite the reaction, such that analytes are able to pass through the membrane and into the perfusate. Large molecules (e.g. proteins) are excluded from the flowing perfusion fluid because of the molecular weight cut-off (MWCO) of the microdialysis membrane. Smaller analytes are able to pass through the membrane and into the perfusate, which then transports the analytes out of the microdialysis sampling area.

As used herein, the term “perfusate” refers to the solution that is introduced into the microdialysis sample (i.e., apparatus/probe). Following passage through the dialysis sampling area (i.e, the area in fluid communication with the enzymatic reaction), the perfusate may also contain one or more analytes from the enzymatic reaction. Sampling using microdialysis does not disturb the kinetics of the enzymatic reaction under study and allows for continuous dynamic time profile changes in a reaction without having to manipulate the sample during the course of the experiment or without affecting the environment of the reaction.

There are many factors which affect the ability to utilize microdialysis to sample and quantitatively analyze large-scale bioprocesses. Many of the factors relate to the dialysis membrane itself, including chemical composition of the membrane, the molecular weight cut-off (MWCO), the morphological structure and degree of porosity/permeability of the membrane, as well as the temperature of the bioprocess, and the structure and properties of the analyte to be measured. In one embodiment, the present invention provides methods and apparatuses for on-line, real-time analysis of bioprocesses, including large-scale, industrial reactions, thereby providing quantitative measures of reaction kinetics that was previously unavailable.

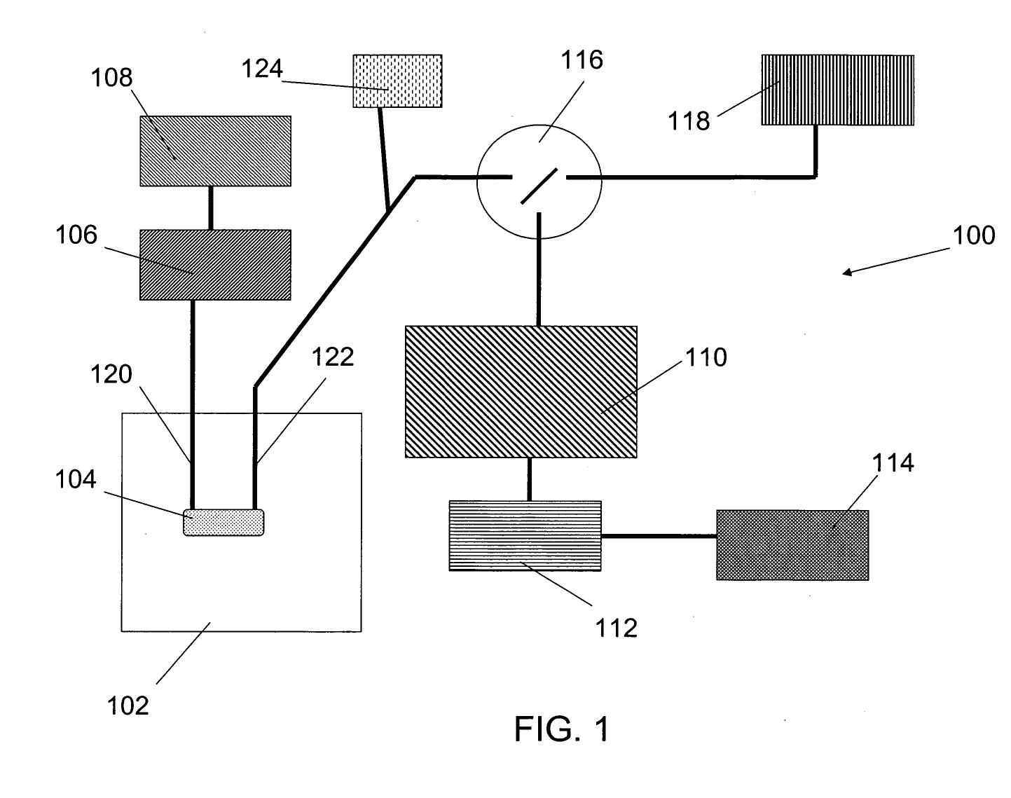

As noted above, microdialysis allows for the removal of one or more analytes from an enzymatic reaction via transport/transfer of the analytes through a dialysis membrane into the perfusate solution so that the analytes can be quantified. FIG. 1 shows an exemplary on-line, real time quantification sampling apparatus 100 for performing the methods of the present invention.

As shown in FIG. 1, suitably an enzymatic reaction will be taking place (or about to be initiated) in a reaction vessel 102. It should be noted that the size of reaction vessel 102 is shown for illustrate purposes only, and can be a large-scale bioprocess vat or container, for example, on the order of one liter or more in size. That is, the amount of enzymatic reaction that is occurring will also suitably be on the order of greater than about one liter or more. In exemplary embodiments, the amount of enzymatic reaction that is being sampled using the various methods of the present invention will be greater than about 5 liters, greater than about 10 liters, greater than about 30 liters, greater than about 50 liters, greater than about 100 liters, greater than about 200 liters, or greater than about 500 liters.

A microdialysis sampler 104 (e.g., a microdialysis membrane, probe or other apparatus) is placed in fluid communication with the enzymatic reaction. In exemplary embodiments, microdialysis sampler 104 is placed within the reaction vessel so that one or more analytes from the enzymatic reaction can be transferred to the perfusate. It should be understood that microdialysis sampler 104 can be completely submerged in the enzymatic reaction, or can simply be placed in contact with the reaction, i.e., can be part of the vessel itself, such that only the membrane is actually in contact with the reaction. Generally, all that is required is for analytes from the reaction to pass through the dialysis membrane and enter the passing perfusate. In exemplary embodiments, the perfusate is connected to the reaction vessel, meaning that the tubing, pipe, or other suitable carrier carrying the perfusate flowing through the microdialysis apparatus is attached, connected, fixed, or otherwise directly associated with the reaction vessel. In other embodiments, the perfusate is indirectly connected to the reaction vessel. For example, the perfusate can be connected to an external volume, which is itself connected to the reaction vessel. For example, a tubing, pipe or other carrier can be attached to the reaction vessel such that a portion of the enzymatic reaction flows through the external volume prior to returning to the reaction vessel (e.g., a continuous loop outside of the reaction vessel). The perfusate can be connected to this external volume, for example, by connecting a microdialysis probe/apparatus/system to the external volume. Thus, while the perfusate is indirectly connected to the reaction vessel.

Microdialysis samplers/apparatus/probes and membranes are selected depending upon the analytes to be sampled and the environment of the enzymatic reaction. Persons of ordinary skill in the art in the field know how to select acceptable microdialysis membranes. The terms “microdialysis sampler,” “microdialysis apparatus,” and “microdialysis probe” are used interchangeably throughout to refer to devices which are used in microdialysis, typically comprising a microdialysis membrane, a support structure for the membrane, and a mechanism for flowing perfusate in contact with the membrane, such that analytes are able to diffuse into the perfusate. In addition, for large-scale, industrial bioprocess applications, it may be important to protect the microdialysis sampler from contamination as well as physical contact from various components, currents, etc, in the processes. Thus, as discussed throughout and in the Examples, microdialysis samplers for use in the practice of the present invention may further comprise a protective cover, coating or other device for shielding the sampler. Such a cover should not, however, limit or impact the transfer of analytes into the perfusate, and thus must be porous enough to allow transfer, while still protect the sampler from large particles or debris in the enzymatic reaction. In one embodiment, the protective cover is attached to the dialysis membrane. In other embodiments, the protective cover is attached to a support member, and therefore is not directly attached to the dialysis membrane.

Exemplary dialysis membrane materials for use in the practice of the present invention include, but are not limited to, polysulfone (PS), polyethersulfone (PES), poylacrylonitrile (PAN), regenerated cellulose (RC), cellulose ester (CE), polyamide (PA), polycarbonate (PC) and polycarbonate/cellulose ester copolymer (PC/CE). As discussed herein, and throughout the examples, the choice of dialysis membrane, as well the composition, flow rate and temperature of perfusate are unique characteristics that are determined for each individual application.

As shown in FIG. 1, microdialysis sampler 104 is suitably connected to a pump 106 and a controller 108. Controller 108 is used to regulate the speed of pump 106, and therefore the flow rate at which the perfusate passes through the sampler. As the diffusion of analytes through the dialysis membrane is diffusion limited, one should monitor and control the flow rate of the perfusate so that measurable amounts of the various analytes are collected. In exemplary embodiments, perfusate is passed into sampler 104 through inlet 120, analytes are transferred to the perfusate through the dialysis membrane, and then the analytes and perfusate exit at outlet 122.

In order to allow for on-line, real-time quantification of analytes of an enzymatic reaction, it may be important to modulate the concentration of the one or more analytes to a quantifiable concentration. Analytes in enzymatic reactions are present at an initial concentration. Though changing as the reaction progresses, at particular points in time, their concentrations are fixed. As these analytes are transferred from the enzymatic reaction to the perfusate, it may be necessary to modulate the concentration of the analytes so that they are present in the perfusate in quantifiable concentrations. As used herein, the term “quantifiable concentrations” means a concentration of perfused analyte(s) that can be measured and quantified (i.e., a numerical value of the amount of analyte can be determined, e.g., moles, grams, parts per million, etc.).

In exemplary method for modulating the concentration of the perfused analytes comprises flowing the perfusate at a measured flow rate, wherein the flow rate achieves a quantifiable concentration of the one or more perfused analytes. As used herein, a “measured flow rate” refers to a flow rate that is specifically designed/determined and implemented into the sampling methods such that a quantifiable concentration of the perfused analytes is achieved. A measured flow rate can be achieved in various ways, for example, through controller 108 which controls pump 106. Pump 106 can be any suitable apparatus for regulating the flow of perfusate, for example, a syringe, mechanical pump, flow regulator, or other suitable device. The flow rate of perfusate can be controlled to very tight standards between the ranges of about a few nL/min to about 100 mL/min, though suitably the perfusate flow rate will be between about 100 nL to about 500 L/min, about 100 nL to about 50 μL/min, about 100 nL to about 10 μL/min, about 100 nL to about 1 μL/min, about 100 nL to about 500 nL/min, or about 100 nL to about 300 nL/min.

By controlling the flow rate, the dilution of the analytes, i.e., the concentration, is controlled as the rate of transfer of the analytes through the dialysis membrane is diffusion limited. Thus, if a high flow rate is used, the concentration of analytes in the perfusate will be relative low (for a fixed volume of perfusate), as perfusate passes through the dialysis system and carries away any analytes that have diffused through the membrane. For slower flow rates, more analytes are able to cross the membrane into the perfusate for a given time, thus a given volume of perfusate may have a fairly high concentration of analytes. In such situations, it may be important to dilute the perfused analytes with one or more diluents. Thus, in addition to modulating the concentration of perfused analytes by controlling the flow rate, the perfused analytes can also be diluted by adding a diluent to the perfusate. Exemplary diluents include water, aqueous solutions, organic solutions and other solvents. A diluent can be added at any time during the sampling and analysis process, for example, before separating the analytes, and/or before detecting the analytes. The amount(s) of various diluents that are added to the perfusate are readily determined by those of ordinary skill in the art. Suitable dilutions include, for example, diluting the analyte(s) by a factor of about 1:10, about 1:100, about 1:1000, about 1:10,000, or about 1:100,000, including dilutions between these values, as well as lower and higher dilutions.

In embodiments where a low flow rate is used, for example less than about 500 nL/min, less than about 100 nL/min, less than about 75 nL/min, less than about 50 nL/min, less than about 25 nL/min, less than about 10 nL/min, or about 6 nL/min, it may be important to dilute the perfused analytes in order to achieve quantifiable concentrations of the perfused analytes. In fact, the present invention provides methods for transferring one or more analytes to a perfusate at flow rates that are less than about 50 nL/min, such that equilibrium is achieved between the reaction mixture and the perfusate. That is, the concentration of analytes in the enzymatic reaction will be the same, or substantially the same as the concentration of analytes in the perfusate. Often, this amount of analyte overwhelms the detection limits of the various detectors disclosed throughout. Thus, it may be important to dilute the perfused analytes with a diluent prior to quantifying. Various pumps/apparatus for controlling the flow rate of perfusate are described throughout, including the examples. Flow rates less than about 100 nL/min can be achieved using, for example, a milliGAT™ pump from Global FIA, Fox Island, Wash.

In further embodiments, one or more internal standards can be introduced into the enzymatic reaction and/or perfusate prior to the quantifying. Internal standards aid in quantification of the analytes by helping to determine the dilution factor of the sample (i.e., how much dilution has occurred due to the diffusive transport into the perfusate), in determining the detection limits of the detection devices, and also in determining the amount of analytes present in a sample. Exemplary internal standards for use in the practice of the present invention are described throughout, including the Examples, and are often compounds that are similar to the substrates and/or products, but that are distinct enough such that they do not interfere with the detection of the analytes. Internal standards can be added to the enzymatic reaction at a known amount, and/or can be supplied in the perfusate prior to analyte transfer from the enzymatic reaction, and/or can be supplied to the perfusate in a diluent after transfer from the enzymatic reaction. For example, internal standards can be supplied in pump 106 prior to passing the perfusate through microdialysis system 104, and/or by diluter 124 after the perfusate has passed through microdialysis system 104. In exemplary embodiments, the amounts and/or characteristics of internal standard(s) are used to correct or adjust a detector(s) so that the quantification of one or more analytes is accurate and within the quantifiable range for the detector. For example, the amount of an internal standard can be used to set a maximum (or minimum) level of detection, and/or used as a known concentration amount to calibrate the detector(s).

In exemplary embodiments, the one or more analytes that are transferred from the enzymatic reactions are substrates and/or products of enzymatic reactions. As used herein, a “substrate” of an enzymatic reaction refers to the chemical species which is acted upon by the enzyme(s) of an enzymatic reaction. The results of enzymatic reactions are referred to herein as “products,” and can include one or more different chemical substances (e.g., breakdown or other converted products). As is well known in the art, the ability to monitor the amounts of substrates and products present at a particular point in time during an enzymatic reaction allow for the determination of various reaction rates and other characteristics of the reaction.

Following transfer of the one or more analytes from the enzymatic reaction, the analytes are then quantified. In one embodiment, in order to quantify the analytes, they are initially separated. For example, as shown in FIG. 1, the perfusate is passed through one or more separators 110. These separators provide a mechanism for separating the various analytes from one another so that they can be quantified. For example, if a sample contains both a substrate and one or more products, it may be necessary to separate the substrates from the products so that they can be separately quantified (often products and substrates have similar chemical characteristics, and thus similar spectra, etc.). Exemplary separators include, but are not limited to, liquid chromatographs (e.g., high performance liquid chromatography (HPLC)), size exclusion chromatography separators and anion exchange chromatographs (e.g., high performance anion exchange chromatography (HPAEC)).

Methods and apparatuses for performing the various types of separation are well known in the art. For example, HPLC, including reversed-phase HPLC, is a well known method of partition chromatography in which the bonded stationary phase packings are nonpolar (e.g. hydrocarbon) and the mobile phase is relatively polar (methanol, acetonitrile, etc.). The long-chain hydrocarbon groups are parallel to one another, forming brush-like structures perpendicular to the silica support. Compounds are separated based on their hydrophobic character, and elute more readily as the proportion of the hydrophobic component of the mobile phase is increased. See e.g., Meyer, V. R., Practical High-Performance Liquid Chromatography, 3rd Edition, 1999, the disclosure of which is incorporated by reference herein in its entirety.

Anion exchange chromatography (AEC) (and high performance AEC (HPAEC)) utilizes an anion exchanger which has charged groups (e.g., NH₃⁺, weak or NR₃⁺, strong) on its surface. The mobile phase contains counter ions, and these ions and the analyte molecules compete for a place on the surface of the stationary phase. Weakly acidic compounds are easily separated at high pH on a strong anion-exchange stationary phase. The situation is the opposite in cation-exchange chromatography, where the stationary phase has negatively charged ionic groups such as SO₃²⁻ and COO⁻. With anion-exchange chromatography, neutral or cationic sample components elute in, or close to, the void volume of the column. Therefore, another degree of selectivity is obtained. Latex-based anion exchange columns, which consist of a sulfonated polystyrene-divinyl benzene substrate and fully aminated porous beads of latex particles (high capacity), are often used because of their stability over a wide pH range (0-14). For example, mono- and oligosaccharides have been separated on anion-exchange columns by using a mobile phase comprised of sodium hydroxide and sodium acetate. See e.g., LaCourse, W. R., et al., Analytical Chemistry 62:220-224 (1990).

Size-exclusion chromatography (SEC), also known as gel filtration chromatography (GFC), involves a stationary phase of porous particles and is dependent on the hydrodynamic radius of the analyte. Molecules that are smaller than the pore size can enter the particles and therefore have a longer path and longer transit time than larger molecules that cannot enter the particles. Molecules larger than the pore size elute together first. This condition is called total exclusion. Molecules that can enter the pores will have an average residence time in the particles that depends on the molecule's size and shape. Molecules that are smaller than the pore size can enter all pores, and have the longest residence time on the column. Thus, the last peak in a chromatogram determines the total permeation limit. The column can be calibrated with a test mixture of compounds of accurately defined molecular mass in order to determine masses of unknowns. See e.g., Skoog, D. A., et al., Fundamentals of Analytical Chemistry, 5th Ed., 1988.

As shown in FIG. 1, in addition to separator 110, apparatus 100 can also further comprise a pump 118 and an injection valve 116, for example with HPLC or HPAEC. Injection valve 116 allows for the user to switch between the perfusate from microdialysis sampler 104 (outlet 122), and the various solvents, etc., provided by pump 118 that are necessary for the separation in separator 110.

Also shown in FIG. 1, apparatus 100 can further comprise a diluter 124. Diluter 124 is used to introduce diluent to the perfusate in order to provide a quantifiable concentration of analytes. Diluter can be various devices, for example, a pump and reservoir containing a diluent (e.g., water, etc.) that is activated when it is determined that the concentration of analytes is not quantifiable, thereby increasing the volume of perfusate and decreasing the total concentration of analytes in the perfusate. As discussed throughout, the amount of diluent added by diluter 124 (i.e., the dilution factor of analyte) is readily determined by those of ordinary skill in the art.

Following separation, the one or more analytes are then detected using detector 112. While separation is not a requirement for the quantitative analysis of the one or more analytes, often analytes which have similar chemical structures (e.g., two similar enzymatic products) will have similar characteristics when they are detected. Examples of detectors for use in the practice of the present invention include, but are not limited to, ultraviolet absorption, fluorescence detection, mass spectrometry, refractive index detection and pulsed electrochemical detection. As shown in FIG. 1, detector 112 is often coupled to a controller 114, for example a computer to record and store the information gathered by detector 112. In exemplary embodiments, controller 114 and controller 108 are the same device, though in other embodiments, two separate controllers/devices can be utilized. Suitably, controllers 114 and 108 are automated controllers. That is, they do not require human intervention to perform during analysis, and are able to control the various aspects of the sampling, separation and detection automatically, in real-time. While only one detector is shown in FIG. 1, the present invention is not limited to use of only a single detector, and more than one detector can be connected to apparatus 100, either at the same time, or detectors can be switched in and out during analysis.

As discussed above, various different detectors 110 can be used in the methods and apparatus of the present invention. Ultraviolet absorption of various analytes is a widely used quantitative analytical technique. See e.g., Skoog, D. A., et al., Fundamentals of Analytical Chemistry, 5th Ed., 1988. When used in combination with liquid chromatography, the difference in absorption between the analyte(s) and the mobile phase background is measured when the analyte(s) passes through a flow cell.

Use of fluorescence detection in combination with a fluorescent tag is another well-known technique. Emission intensity is measured which is proportional to the amplitude of the fluorescence excitation spectrum at the excitation wavelength. Common fluorescent derivatizing reagents include 1,2-di(4-methoxyphenyl)ethylenediamine (DME), 1,2-phenulenediamine (PDM), malonamide, guanidine, benzamidine, 8-aminonaphthalene-1,3,6-trisulfonic acid (ANTS), and various hydrazine derivatives. Derivitization can occur either pre- or post-separation.

Refractive Index (RI) detectors measure the ability of sample molecules to bend or refract light. This property for each molecule or compound is called its refractive index. Detection occurs when light is bent due to analytes present in the perfusate, relative to perfusate alone (or other solvents if additional solvents are added, for example during separation).

In mass spectrometry (MS), analytes must first be ionized prior to detection. The ionized analytes are then passed through a mass analyzer, and the ion current is detected. Most of the ions formed in MS are singly charged; thus, the mass to charge ratio (m/z) can be used to deduce the mass of the ion.

There are various methods for ionization, including electrospray ionization (ESI). Okatch, H., et al., Journal of Chromatography A 992:67-74 (2003). A fine spray of microdroplets is formed as analyte is sprayed from a needle. The solvent molecules are then evaporated, leaving highly charged droplets. Coulombic repulsion overcomes the droplet's surface tension and the droplet explodes, which forms a series of smaller, lower charged droplets, and through repetition, individually charged analyte ions. Xiang, F., et al., Analytical Chemistry 71:1485-1490 (1999), the disclosure of which is incorporated by reference herein in its entirety.

Pulsed Electrochemical Detection (PED) employs a pulsed potential cleaning step (to reactivate noble metal electrode surfaces) for the detection of analytes under alkaline conditions. See e.g., Zook, C. M. and LaCourse, W. R., Current Separations 14:48-52 (1995) and Zook, C. M. and Lacourse, W. R. Current Separations 17:41-45 (1998). PED offers excellent selectivity and sensitivity for analytes of interest.

Examples of enzymatic reactions which can be monitored using the methods of the present invention include any bioprocess, for example, fermentation processes (e.g., for making various alcoholic beverages and foods), consumer/cleaning products and processes (e.g., cleaners, laundry detergents) and bioprocesses used in recombinant gene technology for the production of pharmaceutical agents as well as for the production of methanol and ethanol as alternative energy sources to replace fossil fuels. In these processes, it is routinely important to be able to quantify the levels of carbon sources and metabolic by-products, as these often greatly affect the yield or quality of the desired fermentation/enzymatic products. Carbohydrates (glucose, maltose, starch, etc.) are the major carbon sources essential for cell growth and product synthesis. Alcohols (e.g. ethanol, methanol, sugar alcohols) and organic acids such as lactate and formate are metabolic by-products. Thus, detection of carbohydrates and the enzymatic products of these reactions are required. In one embodiment, the present invention provides methods for quantifying carbohydrate substrates and products (e.g., carbohydrate hydrolysis products) using the methods described throughout. In exemplary embodiments, the amount of enzymatic reaction that is being sampled using the various methods of the present invention will be greater than about 5 liters, greater than about 10 liters, greater than about 30 liters, greater than about 50 liters, greater than about 100 liters, greater than about 200 liters, or greater than about 500 liters, etc. This scale of enzymatic reaction is often utilized in industrial bioprocesses, as discussed throughout.

As discussed throughout, enzymatic bioprocesses and fermentation broths are complex mixtures of nutrients, waste products, cells, cell debris, and analytes of interest. Sampling from the bioreactor often involves the removal of aliquots of fluid, quenching of the reaction, centrifugation, and dilution prior to separation and detection. The present invention eliminates this requirement, providing real-time, on-line quantification of analytes of enzymatic reactions. For example, the use of MD, coupled to various separation and detection techniques, provides for real-time analysis of a bioprocess. That is, analytes can be removed from the reaction vessel without actually removing or tampering with the enzymatic reaction (via transfer to a perfusate). The analytes are then separated if needed, and finally quantitatively detected using the various methods described throughout. The ability to perform these analyses in complex, dynamic, and large-scale, industrial type settings provides extremely useful data to for the various processes and applications described throughout.

In further embodiments, the present invention provides methods for on-line, real-time quantification of one or more products and one or more substrates of an enzymatic reaction. As discussed throughout, one or more substrates and one or more products are transferred from a reaction vessel to a perfusate with a microdialysis sampler (e.g., apparatus/membrane/probe). The concentrations of the perfused substrates and products are then modulated as described throughout to a quantifiable concentration. Then, the perfused substrates and the products are separated (e.g., via liquid chromatography, size exclusion chromatography or anion exchange chromatography) and then detected in real-time (e.g., via ultraviolet absorption, fluorescence detection, mass spectrometry, refractive index detection or pulsed electrochemical detection). As discussed throughout, suitably the reaction vessel comprises greater than about one liter of the enzymatic reaction, for example, greater than about five liters, greater than about 10 liters, greater than about 20 liters, greater than about 30 liters, greater than about 50 liters, greater than about 100 liters, greater than about 200 liters, or greater than about 500 liters, etc.

The present invention also provides methods for on-line, real-time quantification of one or more carbohydrate products and one or more carbohydrate hydrolysis substrates of an enzymatic reaction. In such embodiments, one or more carbohydrate substrates and one or more carbohydrate hydrolysis products are transferred from a reaction vessel into a perfusate with a microdialysis sampler. The concentration of the perfused substrates and products are then modulated to quantifiable concentrations as described throughout. The perfused substrates and products are then separated by anion exchange chromatography, and then detected, in real-time, by pulsed electrochemical detection. Again, as noted throughout, such methods are suitably adapted for analysis of large-scale, industrial bioreactions, such as enzymatic reactions that are larger than about one liter.

In a further embodiment, the present invention provides methods for determining the type or enzymatic characteristics of an unknown enzyme by comparing the activity of a particular enzyme with a known set of analyte characteristics. For example, the methods of the present invention allow for the quantitative determination of analytes (i.e., substrates and products) from a particular enzymatic reaction. Thus, these characteristic analyte “fingerprints” can be compared against a population of analytes produced from an unknown enzymatic process to determine the type or characteristic of the unknown enzyme. The ability to quantitatively determine the amount of substrates and products allows for identification of very subtle differences between similar enzymes.

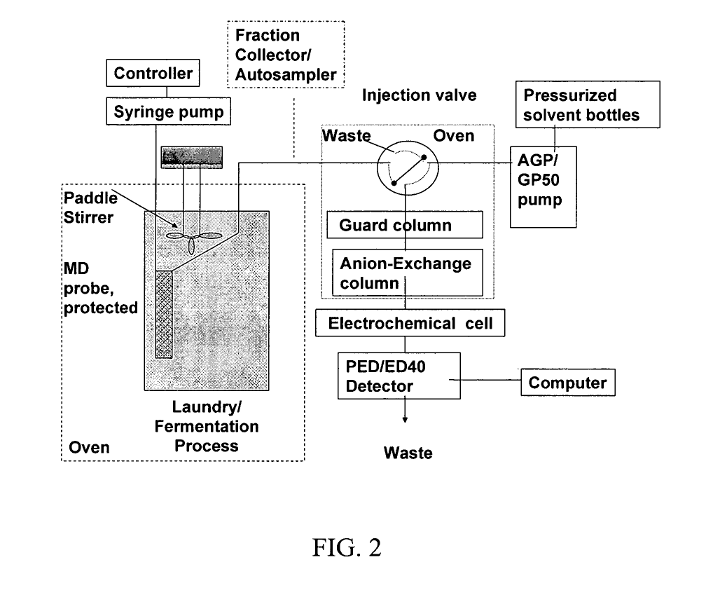

The present invention also provides apparatuses for on-line, real-time quantification of one or more analytes of an enzymatic reaction, for example, as shown in FIGS. 1 and 2. For example, the apparatuses comprise a reaction vessel comprising greater than about one liter of the enzymatic reaction and a microdialysis sampler in fluid communication with the enzymatic reaction. Suitably, the microdialysis sample will have a protective covering, cap or coating, as discussed throughout. The apparatuses of the present invention also suitably comprise one or more pumps for regulating perfusate flow through the microdialysis sampler. As discussed throughout, these pumps can be used to control the flow rate of the perfusate, thereby modulating the concentration of the analytes. Suitably, the apparatuses also comprise a diluter for further modulation of the concentration of the analytes if desired. The apparatuses also comprise one or more separation devices, one or more detectors and an automated controller. As discussed herein, automation of the methods described throughout provides unique advantages to the monitoring, sampling, and on-line, real time quantification of enzymatic reactions, including large-scale, industrial bioprocesses.

It will be readily apparent to those in this field that that other suitable modifications and adaptations to the methods and applications described herein can be made without departing from the scope of the invention or any embodiment thereof. Having now described the present invention in detail, the same will be more clearly understood by reference to the following examples, which are included herewith for purposes of illustration only and are not intended to be limiting of the invention.

### EXAMPLES

General Methodology and Sample Preparation

Separation

For separation, a DX-300 or DX-500 liquid chromatography system (Dionex, Sunnyvale, Calif.) was used. The solvent delivery pumps used in these systems were the Advanced Gradient Pump (AGP, normal bore) and the GP50 pumps (normal bore and microbore), also from Dionex. Solutions were loaded either manually, by a Thermo Separations AS3500 autosampler (Waltham, Mass.), or by microdialysis syringe flow onto an injection valve (Model 9010, 9126, or 9750, Rheodyne, Cotati, Calif.) fitted with an injection loop (2 μL-100 μL volumes). When using the AS3500 autosampler partial loop-filling was used when sample volumes were limiting; otherwise full loop-filling mode was selected. As recommended when using partial loop-filling mode, the injection volume was ≦half the loop size. Data collection and system control was accomplished using PeakNet software (Dionex, Version 4.3 or 5.21) on a 200/33 MHz computer.

RP-HPLC Separation

Reversed-phase separations were achieved using a Phenomenex Luna C18, 5 μm particle size, 250 mm×4.6 mm analytical column (Phenomenex, Torrance, Calif.) and a Phenomenex Security (C8) guard column. The column was temperature controlled at 30° C. with an LC-30 chromatography oven (Dionex). The mobile phase solvents were MeOAc buffer (pH 3.00, 0.05 M) and ACN delivered at a flow rate of 1.00 mL/min. All solvents were filtered, degassed, and kept under pressure (N2, ca. 10 psi).

HPAEC Separation

Anion-exchange separations were achieved using both normal bore AGP and microbore GP50 pumps. For separation, latex-based anion exchange columns, which consisted of a sulfonated polystyrene-divinyl benzene substrate and fully aminated porous beads of latex particles (high capacity), were used. Retention of analytes was achieved using a CarboPac PA100 analytical column (4.6×250 mm for normal bore, 2×250 mm for microbore) protected by a PA1 (4×50 mm) or PA100 (2×50 mm) guard column. Separation was achieved using an LC-25 chromatography oven (Dionex) set at 30° C. or by using the heating assembly that was part of the AS3500 autosampler. The chromatographic data were recorded on a Pentium II computer using Dionex PeakNet software, version 4.3 or 5.21. The mobile phase solvents were sodium acetate and sodium hydroxide delivered at a flow rate of 1.00 mL/min for normal bore and 0.25 mL/min for microbore separations.

Size-Exclusion Chromatography

For size-exclusion chromatography, separation was achieved using the DX-300 system equipped with the AGP and a Dionex Zorbax SE-450 chromatography column. The column contains stable (pH 3-9) spherical, silica-based packings with diol functional groups. The reported separation range (determined using globular proteins) was 15 to 1,000 kDa, the exclusion volume was 6 mL, and the included volume was ca. 11 mL. The mobile phase, 10 mM acetate buffer pH 4.7, was delivered at a flow rate of 1.00 mL/min. Again, all solvents were filtered, degassed, and kept under pressure (N2, ca. 10 psi).

UV Absorption Detection

UV absorption detection was carried out using a Dionex Model AD20 detector. The AD20 is a dual-beam, variable wavelength photometer with two light sources: a deuterium lamp for ultraviolet detection and a tungsten lamp for visible wavelength operation. Wavelengths of 350 nm or 290 nm were selected for analytes of interest.

Pulsed Electrochemical Detection

Pulsed electrochemical detection was accomplished using an older model PED detector or an ED40 electrochemical detector, both from Dionex. For the PED detector, the electrochemical cell was equipped with a 5 mm Au electrode and Ag/AgCl reference electrode, while the body of the cell served as the auxiliary electrode. For the ED40 detector, the electrochemical cell was equipped with a 1 mm Au electrode, a combination pH and Ag/AgCl reference electrode, and a titanium auxiliary electrode. Solutions were analyzed using a standard quadruple-pulsed potential-time waveform controlled by PeakNet software (Dionex, version 4.3 or 5.21) unless otherwise noted. The waveform potentials were as follows: E1=+0.10 V, E2=−2.00 V, E3=+0.60 V, and E4=−0.10 V.

Refractive Index Detection

RI detection was achieved following SEC using a Model SP8430 Spectra Physics refractive index detector (Irvine, Calif.). The settings on the detector were controlled manually from the front panel, and the data collection was accomplished via a Pentium II computer.

Microdialysis Setup

Microdialysis probes were received dry with a protective layer of glycerin, and were placed in water and perfused at a rate of 5 μL/min for >120 minutes prior to experimental use. During experiments, the perfusate was delivered at a set flow rate ranging from 0.1-10 μL/min by use of the BAS and/or KD syringe pumps. Fluorinated ethylene propylene (FEP) tubing and flanged plastic connectors (BAS) were used to connect the syringe pump to the inlet of the MD probe, and from the outlet to the injection loop. A conical adaptor was used to interface the MD to the HPLC (Upchurch Scientific, Oak Harbor, Wash.). In this manner, the analytes were carried away from the sampling region; the dialyzed liquid (dialysate) was delivered to a rear-loading 6-port, 2-position valve. In some cases, fractions were collected using a Foxy Jr. fraction collector (Teledyne Isco, Lincoln, Nebr.) and the components of the individual samples were later separated and detected accordingly. 100 μL robotic polypropylene 9 mm screw thread autosampler vials purchased from Alltech (Deerfield, Ill.) were used for collection. For on-line analysis, the fixed volume loop was continuously filled, and injections were made at fixed time intervals. The pressure of the AGP or GP50 pump allows the sample to be sent from the injection valve to the column and detector.

FIG. 2 is schematic of an exemplary microdialysis-HPAEC-PED set-up useful for analysis of enzymatic reactions in detergent and fermentation settings. Note that the stirring was accomplished using an overhead stirrer from Arrow Engineering Model 6000 overhead mixer (Hillside, N.J.) equipped with a glass rod and Teflon paddle or an EC219 rotator/controller and paddle from IBM Instruments (Danbury, Conn.). For the fermentation experiments, online dilution was achieved via a static mixing tee obtained from Upchurch.

UV-Vis Spectrophotometry

Spectra of analytes were obtained using a Shimadzu 1601 UV-VIS spectrophotometer thermally regulated using a circulating water bath. The instrument has a double beam design and both deuterium and tungsten-halogen lamps. Kinetics experiments were carried out in 3 mL cuvettes using Shimadzu UV Probe software (version 2.01). Glycoside reactions were monitored at 400 nm or 290 nm.

Osmolarity

Fermentation osmolarity studies were carried out on a Wescor Model 5100 Osmometer. Mannitol solutions were prepared at 1, 5, 10, 15, and 20 volume % concentrations in water. A liquefied corn mash fermentation sample was centrifuged at 3000 g for 20 minutes. The supernatant was removed for osmolarity readings. Calibration was achieved using a 280 mg/kg and 1000 mg/kg salt solution. 10 μL of each sample was used for osmolarity readings. Samples were run in triplicate and average readings were used to make a standard curve to determine the osmolarity of the corn mash solution.

Polypropylene Screen Construction

As laundry detergent processes involve agitation of cloth in the detergent solution, the ruggedness of the microdialysis probe to withstand this agitation becomes important. Protection of the probe by means of an outer sleeve was investigated using sheets of various mesh sizes. Investigation began with a 1000 μM mesh, and a 3″ by 3″ polypropylene mesh square was cut, and then folded in half. Two of the three open edges were sealed using a soldering gun, leaving the top open to hold the loop probe. Microdialysis recovery was measured for the probe alone, and the probe inside of the polypropylene pocket. The microdialysis perfusion flow rate was 10 μL/min. A standard mix of 1 ppm M1-M7 and 1 ppm cellobiose (I.S.) was used for recovery experiments. The sleeve was attached to the side of the detergent vessel by a clip, and was washed, sonicated, dried, and reused for additional experiments.

Preparation of Corn Starch Solution

Starch solutions were made using Argo brand corn starch from Bestfoods (Englewood Cliffs, N.J.). A 1% solution was made by adding 10 g of starch to ˜1 L of water (1 g for a 0.1% solution). The solution was prepared by heating the suspension to boiling with stirring and holding at boiling temperatures for ca. 15 minutes, then cooling to room temperature. The volume was brought up to exactly 1 L with water using a volumetric flask. 500 mL of the starch solution were used for each detergent study (1:2 dilution).

Preparation of Detergent Solutions

The detergent vessel consisted of a 1000 mL glass beaker, and the solution was stirred at a rate of 100 RPM with an Arrow Engineering Model 6000 overhead mixer (Hillside, N.J.) equipped with a glass rod and Teflon paddle. Detergent processes were made according to Novozymes (Franklinton, N.C.) specifications, as described below. An enzyme-free detergent solution was made by using 1.5 g Purex® laundry detergent/1 L water. To mimic typical water hardness, a stock solution (Solution A) of 0.2 M calcium acetate/0.1 M magnesium acetate was made as well as a stock solution (Solution B) of 1.1 M NaHCO₃. The amounts added to the 1 L detergent process were 5 mL Solution A and 4 mL Solution B to achieve 150 ppm hardness and 295.2 mg/L of sodium bicarbonate, respectively. Acetate salts were used (molar equivalents) as a substitution for the standard chloride salts as Cl³¹ has a deleterious effect on the electrode over time. Cellobiose was added as the internal standard at a concentration of 1 ppm. At the start of the detergent process, the amylase enzyme was added at a concentration of 15 mg/L (equivalent to 1% of detergent concentration).

Sampling in Laundry Detergent Solutions

For HPAEC-PED detergent analysis, fractions were collected by hand into 100 μL polypropylene vials (5 minutes=50 μL of dialysate per vial), capped, and placed in an autosampler for analysis. For SEC-RI analysis aliquots (1 mL) of fluid were removed from the detergent process every minute. To this 1 mL solution, 50 μL of 25% NaOH was added immediately to bring the pH to >13 and quench the reaction. Immediately before analysis by SEC-RI, 150 μL of 10% H₂SO₄ was added to bring the pH to ˜4, in order to be in the acceptable pH range of the column. Samples were then filtered with 0.2 μm PTFE filters and loaded onto the injection loop.

Preparation of Fermentation Mash and Glucoamylase Samples

A 2 L volume of liquefied corn mash was provided by Novozymes Corporation in two separate 1 L containers. The solid matter in the mash was reported to be 32% and was shipped frozen. The first liter was thawed in a 32° C. water bath, shaken vigorously, and divided into 5 fractions of ˜200 g each. Approximately 2 g of each fraction was transferred onto a Petri dish and massed on an Ohaus analytical balance (Pine Brook, N.J.). The samples were then dried at 100° C. in an oven until constant mass was attained. The dry sample mass divided by the original wet sample mass was used to calculate the percent solids in the fraction. A value of 32±1% was considered acceptable. The same procedure was repeated for the second liter of mash, with the fractions being smaller (˜50 g) each. Experiments were conducted on one fraction as a time (remaining fractions were frozen until use). Mash reactions were carried out at 32° C. and stirred at a rate of 100 RPM.

For HPAEC-PED fermentation analysis, dialysate was collected and were diluted either manually (1:10,000 or 1:500) in water or on-line (1:101) using two syringe pumps and a tee-junction. Manually diluted solutions were transferred to autosampler vials, capped, and placed in the autosampler for analysis. On-line analysis was carried out by sending the outflow from the tee-junction directly to the injection valve of the HPAEC-PED system.

### Example 1

### Applications of In Vitro Microdialysis to Laundry Detergent Monitoring

Enzymes have been used in the laundry industry since 1913. Other enzymes were later added, including amylases in 1973, which are used to degrade starch stains to water-soluble sugars, and cellulases in 1987, which remove cellulose microfibrils released in cotton after repeated washing. The amylases used in the detergent process are found in the alkaliphilic Bacillus strains. The maximum activity for these enzymes falls in the pH range of 9.0 to 11.5

The use of enzymes in detergent formulations is now common in developed countries, with over half of all detergents presently available containing enzymes for the removal of stains. Stains come in many forms including proteins, starches and lipids. For this reason, proteases, amylases and lipases are commonly found in laundry detergents. Using detergents in water at high temperatures and with vigorous mixing, it is possible to remove most types of dirt but the cost of heating the water is high and lengthy mixing or beating will shorten the life of clothing and other materials. The use of enzymes allows lower temperatures to be employed and shorter periods of agitation are needed, often after a preliminary period of soaking. In general, enzyme detergents remove protein from clothes soiled with blood, milk, sweat, grass, etc. far more effectively than non-enzyme detergents. Enzyme effectiveness is often determined by antiquated colorimetric tests that are lacking in sensitivity and selectivity.

Starch Degrading Enzymes

Some laundry detergents contain amylase enzymes to help remove starches from clothing. These enzymes decompose starch into water-soluble degraded products, which are carried away with the wash water. Endoamylases such as the α-amylase enzymes are able to cleave the α1-4 glycosidic bonds present in the inner part (endo-) of the amylose or amylopectin chain. The enzyme α-amylase (EC 3.2.1.1) is a well-known endoamylase that is found in a wide variety of organisms. The end products of the α-amylase action are oligosaccharides with varying length (with an α-configuration) and α-limit dextrins, which constitute branched oligosaccharides. The extent of hydrolysis is normally expressed in terms of the dextrose equivalent (DE) or degree of polymerization (DP). A higher DE represents greater extent of hydrolysis, yielding smaller average MW sugars. Conversely, the higher the DP is, the larger the sugar. Currently, to determine the efficacy of the enzymes, a colorimetric test is commonly employed using commercially available fabric swatches soiled with dyed corn starch provided by the Switzerland-based company EMPA. However, since no enzymatic breakdown product information is obtained, the comparison between enzymes can be difficult.

Three amylases (Bacillus sp., Bacillus amyloliquefaciens and Bacillus licheniformis) were tested in laundry detergent wash processes to see if a visible difference could be observed and correlated to enzyme performance

Detergent Washes

Briefly, an enzyme-free detergent solution was made by using 1.5 g Purex® laundry detergent/1 L water. In order to mimic typical water hardness, calcium acetate, magnesium acetate and NaHCO₃ were added by the procedure described above. Stirring was accomplished by use of an overhead stirrer at a rate of 100 RPM. At the start of the detergent process, swatches of EMPA cloth were added to the wash process. Additionally, the amylase enzyme was added at a concentration of 15 mg/L. It was determined that using the color-based test, it was difficult to definitively determine which enzyme is hydrolyzing the stain most effectively (results not shown).

Direct Determination of Maltooligosaccharides by HPAEC-PED

Amylases act to remove starch from soiled cloth by hydrolyzing the starch into smaller glucopolymers and oligosaccharides. These products were separated by HPAEC and detected by PED. Starch contains both linear α-(1→4) amylose and branched α-(1→6) amylopectin, and the relative ratio depends on the source of the starch. Thus, both maltooligosaccharides and limit dextrans were expected to be products of the hydrolysis.

Direct determination of the carbohydrates that are formed in industrial processes (i.e. detergent wash processes) through starch hydrolysis can be used to compare enzyme efficiency. Amylases in detergents help to remove starch from soiled cloth by hydrolyzing the starch into smaller glucopolymers and oligosaccharides. Maltodextrin, corn starch and amylopectin were chosen as model substrates for the amylase reactions. Seven model carbohydrates were monitored during the process: glucose (M1), maltose (M2), maltotriose (M3), maltotetraose (M4), maltopentaose (M5), maltohexaose (M6), and maltoheptaose (M7).

Maltodextrin is sold as a white powder that is produced by partial hydrolysis of starch by a typical total enzyme process using a bacterial α-amylase followed by refining and spray-drying to a moisture level of 3% to 5%. Maltodextrin is a mixture of glucose, maltose, oligosaccharides and polysaccharides.

Preliminary microdialysis experiments were carried out to determine if starch and its degradation products would be able to cross the microdialysis membrane and be separated and detected by HPAEC-PED. These experiments were carried out using commercially available PAN BR-4 probes from BAS. However, with the small dialysis window (4 mm), recovery of analytes was low, and therefore the 3 cm loop probes were chosen as a replacement. Using these probes with a low syringe pump flow rate (5 μL/min), the recovery of maltodextrin components across the membrane was easily observed at a solution concentration of 25,000 ppm.

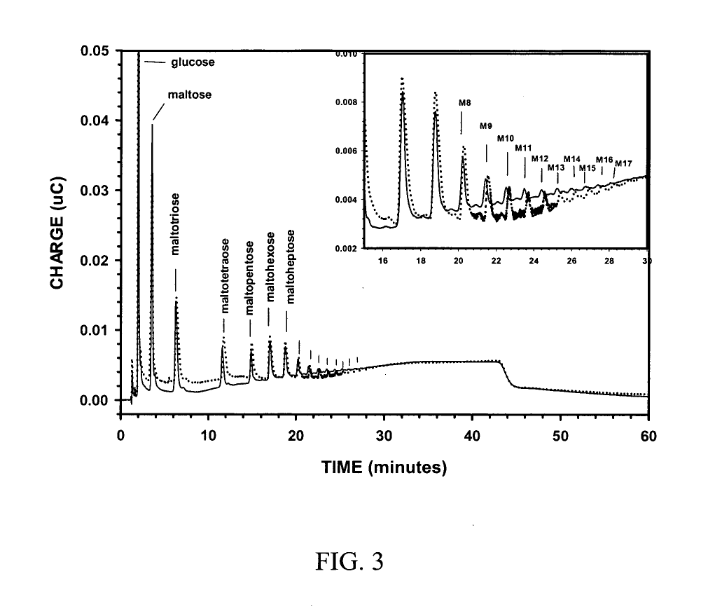

The dialysate from the microdialysis set-up was collected and injected onto the analytical system. Using a gradient of sodium acetate (50 mM-300 mM) in a background of 100 mM NaOH, it was found that the maltooligosaccharides were recovered across the membrane, and that a good separation was demonstrated for the analytes of interest (FIG. 3). FIG. 3. shows chromatograms from HPAEC-PED analysis of maltodextrin (25,000 ppm) by direct injection ( . . . ) and following microdialysis clean-up with a 3 cm loop probe. Loop size 25 μL, perfusion flow rate 5 μL/min.

Peaks could be observed for 17 components present in the maltodextrin solution. These were assumed to be maltooligosaccharides M1-M17, but peak identities could only be confirmed for M1-M7 by spiking due to the lack of availability of higher MW standards.

Testing of MD Recovery in Tide® Laundry Detergent Solution

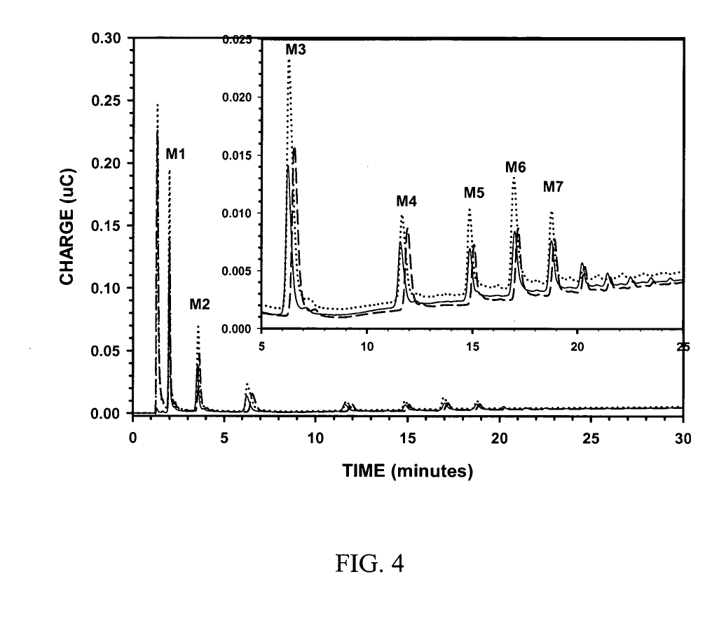

Testing of the membrane in the presence of Tide® liquid laundry detergent was accomplished as follows. A small volume of Tide® was deactivated by placing it in boiling water for a period of three minutes. A 1.5 mg/mL solution of Tide® was prepared with a 25,000 ppm maltodextrin starting concentration. Using inactive Tide®, similar recoveries were obtained (determined qualitatively by observation of peak heights) for the analytes of interest (FIG. 4), implying that the denatured enzymes and other matrix components were not interfering with the transport of analytes across the membrane. In the presence of active Tide®, the smaller maltooligosaccharides increased in concentration, indicating that the amylases in the detergent were digesting the larger carbohydrate oligomers and releasing the products into the detergent solution. Overlayed chromatograms for these processes can be seen in FIG. 4. FIG. 4. shows overlapping chromatograms of 25,000 ppm maltodextrin microdialysates blank (______) and in the presence of denatured ( - - - ) and active ( . . . ) Tide® sampled from 1 to 4 hours into the enzymatic reaction. Detergent concentration 1.5 mg/mL. Inset shows enlargement of 5 to 25 minute region.

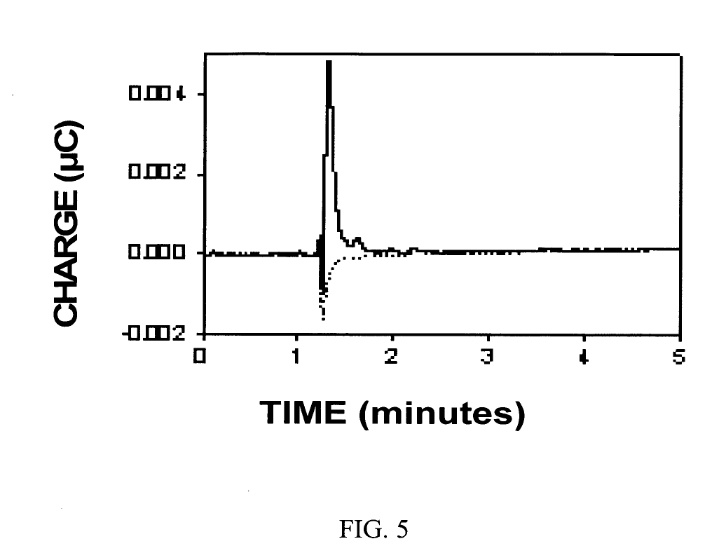

In order to further understand and verify the activity of the amylases in the laundry detergent, a larger branched carbohydrate polymer, amylopectin, was chosen for further studies. This maize starch is too large to be able to pass through the pores of the microdialysis membrane, as observed in FIG. 5. Again, there is a slight background signal from the Tide® detergent that can be observed eluting ca. 1.5 min in the chromatogram. The background signal was not found to interfere with the detection of early eluting carbohydrates such as glucose. Additionally, the separation can be modified and the acetate gradient can be lowered at the beginning of the separation to allow for longer retention of analytes of interest if desired.

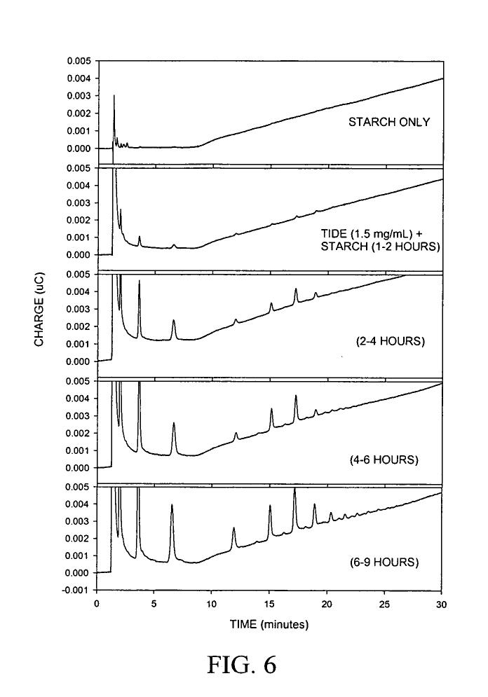

When the active Tide® detergent (1.5 mg/mL) was added to the amylopectin (2000 ppm), the result is the release of maltooligosaccharides that can be monitored over time (FIG. 6). It was seen that the recovery of breakdown products of starch could be achieved by this method.

The chromatograms show that a variety of carbohydrates are obtained from the enzymatic hydrolysis of amylopectin, and that this method is amenable to carbohydrate monitoring in this industrial process. However, the time frame for analysis required to see the compounds of interest (1-9 hours) is unreasonable as laundry detergent processes currently operate in 15 minutes or less. Additionally, while these results are merely qualitative and an internal standard was not used, the desired end result was to achieve quantitative results so as to accurately compare enzyme efficacy in these processes.

Improving the Signal to Noise Ratio

The first step in improving the analytical utility of this method was to improve the signal to noise ratio (S/N) for the analytes of interest. This was first attempted by changing to a microbore HPAEC-PED. There are multiple advantages to using this type of system, including less solvent consumption, smaller sample volumes, and increased sensitivity. A Dionex system with GP50 microbore pump and ED40 electrochemical detector was used for separation and detection of carbohydrates.

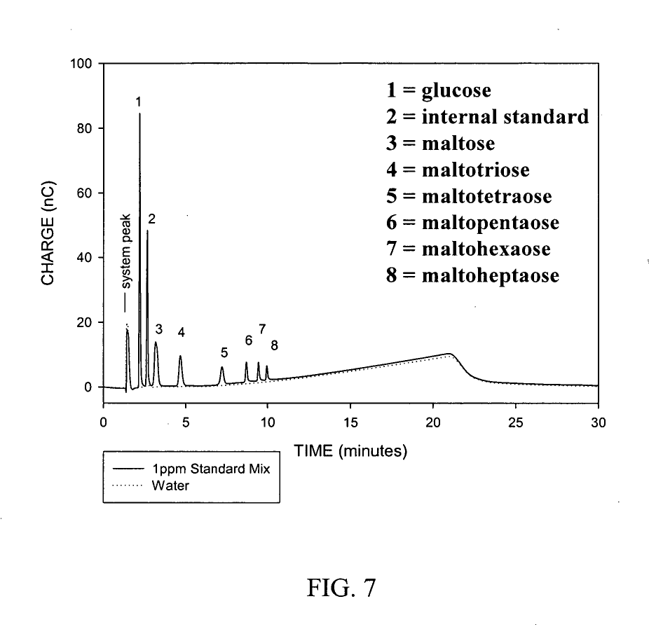

Solutions of model compounds glucose (M1), maltose (M2), maltotriose (M3), maltotetraose (M4), maltopentaose (M5), maltohexaose (M6), and maltoheptaose (M7) as well as the internal standard cellobiose (I.S.) were used in these experiments. These compounds were selected in place of maltodextrin as they could be used either individually or as a mixture for accurate quantitation. As the maltodextrin is a hydrolysis product containing unknown amounts of sugars, it could not be used for quantitative purposes. Injections of a 25 μL volume were carried out to determine the linear range and limits of detection for M1-M7. Standards were run separately for identification, and then as a 1 ppm mix. Separation of maltooligosaccharides was achieved using a Dionex CarboPac PA100 guard and PA100 (2×250 mm) analytical column temperature controlled at 30° C. An acetate gradient in sodium hydroxide was used to separate the analytes of interest (see Table II). Solutions were analyzed using a standard quadruple pulsed potential-time waveform. A separation of M1-M7 (1 ppm mix) is shown in FIG. 7.

TABLE II
Gradient for chromatographic separation of M1-M7.

| | % A (0.1 M NaOH/ | % B (0.1 M NaOH/ |
|---|---|---|
| Time (min) | 0.07 M NaOAc) | 1.0 M NaOAc) |
| 0.00 | 100 | 0 |
| 2.00 | 100 | 0 |
| | gradient | |
| 18.00 | 40 | 60 |
| 18.01 | 100 | 0 |
| 30.00 | 100 | 0 |

Analytical figures of merit for these model compounds are listed in Table III. It is important to note that the limits of detection (LODs) show an improvement in S/N of almost 2 orders of magnitude from the normal bore DX-300 system with the older model PED cell. The linear range of all analytes is approximately 3 orders of magnitude. Area data were preferred over height data as better linearity was observed over a wider range; additionally, small shifts in retention time that were observed during analysis could be better corrected for by area data.

TABLE III
Analytical figures of merit for glucose and
maltooligosaccharides.

| | | | | LOD | |
|---|---|---|---|---|---|
| Peak | | Sensitivity area | | (ppm, | LOL |
| No. | Analyte | counts = a(ppm) + b | R² | nM) | (ppm) |
| 1 | Glucose | y = 3057375x + | 0.997 | 0.0002, | 5 |
| | | 140899 | | 1 | |
| 2 | Cellobiose | y = 1976461x + 94699 | 0.989 | 0.0002, | 2 |
| | | | | 0.6 | |
| 3 | Maltose | y = 1712700x + 40620 | 0.997 | 0.001, 3 | 2 |
| 4 | Maltotriose | y = 1057079x + 43871 | 0.991 | 0.002, 3 | 2 |
| 5 | Maltotetraose | y = 608837x + 48879 | 0.982 | 0.003, 4 | 2 |
| 6 | Maltopentaose | y = 481707x + 10003 | 0.990 | 0.002, 2 | 1 |
| 7 | Maltohexaose | y = 403518x + 11795 | 0.982 | 0.002, 2 | 1 |
| 8 | Maltoheptaose | y = 285909x + 7420 | 0.982 | 0.003, 2 | 1 |

LOD estimated as 3 * S/N from lowest injected concentration

Development of a Microdialysis Screen for Protection of Membrane

As true laundry detergent processes involve agitation in the detergent solution, the ruggedness of the microdialysis probe to withstand this agitation becomes important. Protection of the probe by means of an outer sleeve was investigated. Polypropylene sheets of mesh sizes of 1000, 500, 250, 149, 125, and 105 μm were purchased and used to construct 3″×1.5″ pockets to protect the probe from larger particles and debris. Polypropylene was chosen over other materials such as nylon and stainless steel for its strength and stability, low specific gravity (0.91), high melting temperature, and resistance to acids and alkalis as well as other chemicals.

Polypropylene sleeves were constructed as described above. Microdialysis recovery was measured for the probe alone, and the probe inside of each individual polypropylene pocket. The microdialysis perfusion flow rate was 10 μL/min. A standard mix of 1 ppm M1-M7 and 1 ppm cellobiose (I.S.) was used for recovery experiments. Recovery values were determined from the response factors of standard solutions that were directly injected.

Microdialysis recovery was accomplished for all six polypropylene mesh sizes. The 250 μM mesh sleeve was the smallest sized screen that showed no significant decrease in recovery for all analytes of interest (as determined from the standard deviations for the unprotected microdialysis probe). The 250 μM screen was selected as the optimal size to protect the microdialysis probe for the actual laundry detergent experiments. Smaller screen sizes (149 μM and 125 μM mesh) showed decreases in recovery for several analytes results (lower than bracketing standards recovered with the naked microdialysis probe). An unexpected increase in recovery was observed for several analytes using the smallest mesh size (109 μM), and M5 was found to be statistically out of the range. The reason for this increase is not clear. It is possible that the surface of the mesh is somehow interacting with or trapping the analytes.

Comparison of Amylases in Corn Starch Wash Processes by MD-HPAEC-PED

Starch breakdown products M1-M7 were sampled by microdialysis and directly measured by HPAED-PED. The same three α-amylases from the genus Bacillus were selected for studying the breakdown of starch in this manner. Since most starch stains in laundry processes are from corn starch, this source was chosen as the model substrate or stain for quantitative microdialysis experiments. A 0.05% (w/v) corn starch detergent solution was used in order to provide results in the linear range of the detector.

As the chromatographic separations took 35 minutes each and were longer than the entire wash process, the collection of fractions and subsequent analysis was necessitated. For this wash process, fractions of the microdialysate were collected by hand into 100 μL robotic polypropylene 9 mm screw thread autosampler vials. These vials were ideal for collecting small volumes of dialysate and could be easily loaded into the autosampler without additional manipulation.

The microdialysis loop probe protected by the polypropylene 250 μM mesh screen was placed in the detergent process without any amylase present. The perfusion flow rate was 10 μL/min. After ˜60 minutes for equilibration time, the dialysate was collected for ˜10 minutes. This was used for the time point zero measurement. A stock solution of 15 mg/mL amylase enzyme was prepared, and 1 mL of this solution was added to the detergent process. Dialysate samples were collected in 5 minute intervals for a 20 minute time period. Thus, 50 μL of dialysate were collected in each vial. These vials were capped, placed in the autosampler, and analyzed by HPAEC-PED. Experiments were carried out at ambient temperature, which ranged from 24-25° C.

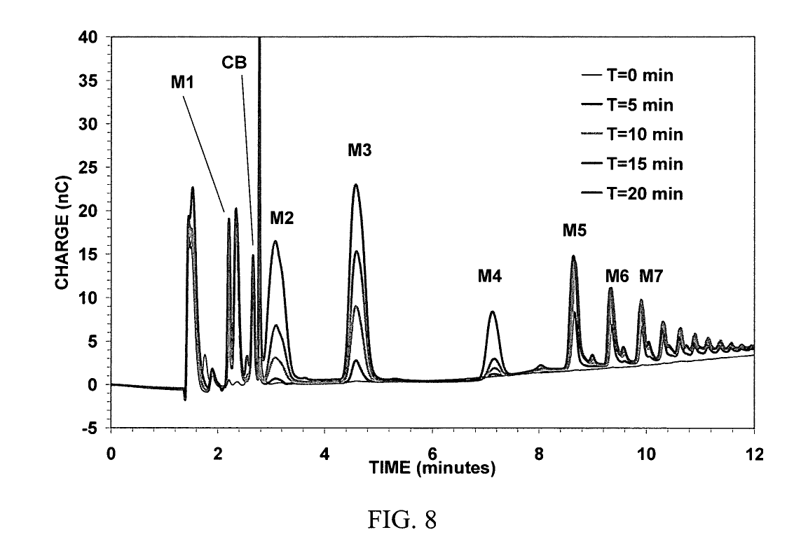

Representative chromatographic results of the starch hydrolysis for the Bacillus licheniformis α-amylase laundry wash experiment (FIG. 8) are shown. An increase in most of the maltooligosaccharides can be observed over time, at 0 min, 0-5 min, 5-10 min, 10-15 min, and 15-20 min. An injection of 1 ppm cellobiose standard bracketed each set of experiments. Response factors were taken from an average of these standards. The actual concentrations in the detergent process were determined by the recovery of the internal standard and from the signal ratio of I.S./analyte for standard solutions. The results for a set of experiments were normalized based on the signal of the internal standard.

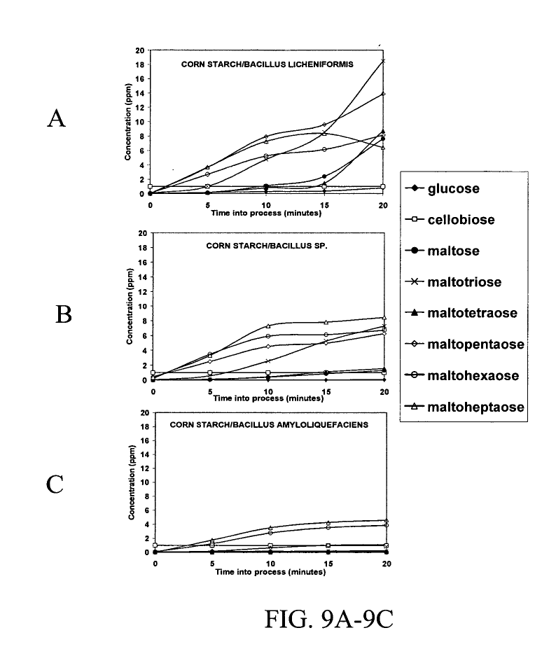

Line graph representations of concentration (ppm) vs. time (minutes) for the analytes of interest for all three enzymatic experiments are displayed (FIGS. 9A-9C.). Note that the smooth curves connecting the points are not a prediction of experimental values, but are present only to facilitate the visualization of trends in the data.

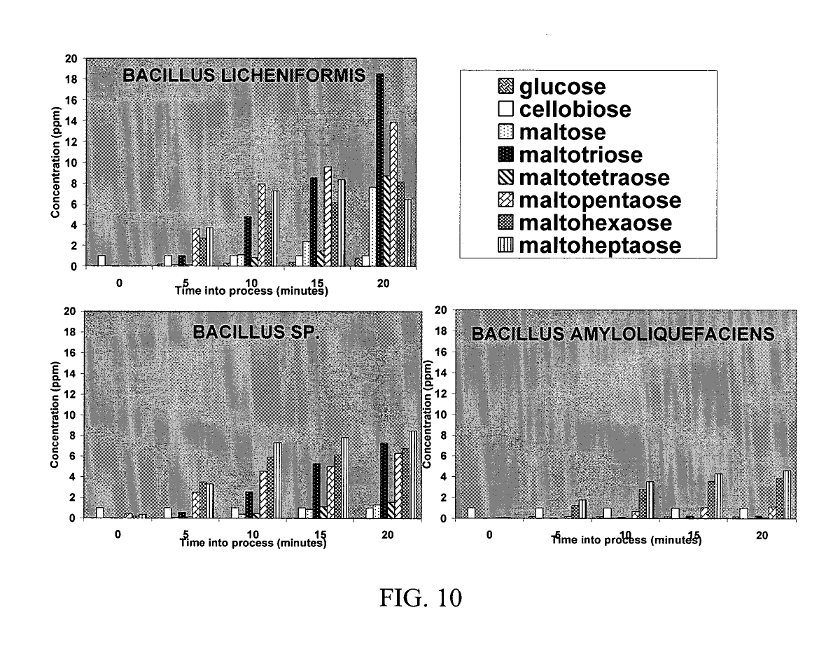

FIG. 10 is a bar graph comparison of M1-M7 production during the three enzymatic processes. Shown in this manner, the order of activity is clear (Bacillus licheniformis>Bacillus sp.>Bacillus amyloliquefaciens); additionally, differences in the production of a particular analyte between enzymes can be quickly and easily compared.

Comparison of Amylases in Cloth Wash Processes by MD-HPAEC-PED

Microdialysis sampling-HPAEC-PED was used to determine the sugars in starch detergent processes containing EMPA 161 and Heinz baby food soiled fabrics.

In place of a liquid corn starch solution, eight squares of cloth were added to the detergent mixture, and the microdialysate was collected to determine whether any maltooligosaccharides were observed in the absence of enzyme. The amylase enzyme was added at a concentration of 15 mg/L (=1% of detergent concentration), and the reaction was monitored. Again, the microdialysate from these experiments was collected in five minute (50 μL) fractions and analyzed by HPAEC-PED according to the method described above. Experiments were carried out at ambient temperature, which ranged from 24-25° C. The hydrolysis products of amylase reactions (maltooligosaccharides M1-M7) were monitored during the course of laundry detergent plus cloth processes. The height of the internal standard, cellobiose, was used as a correction factor to normalize the responses observed for all experiments and to allow for accurate comparisons.

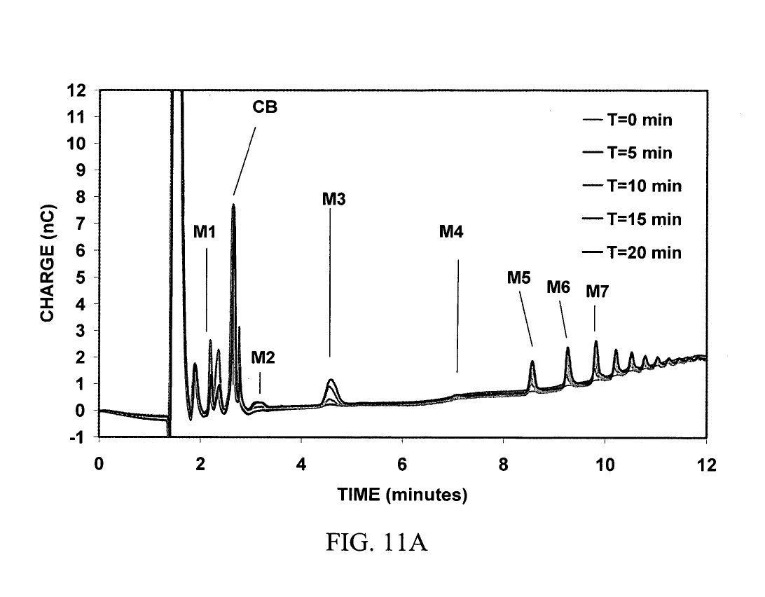

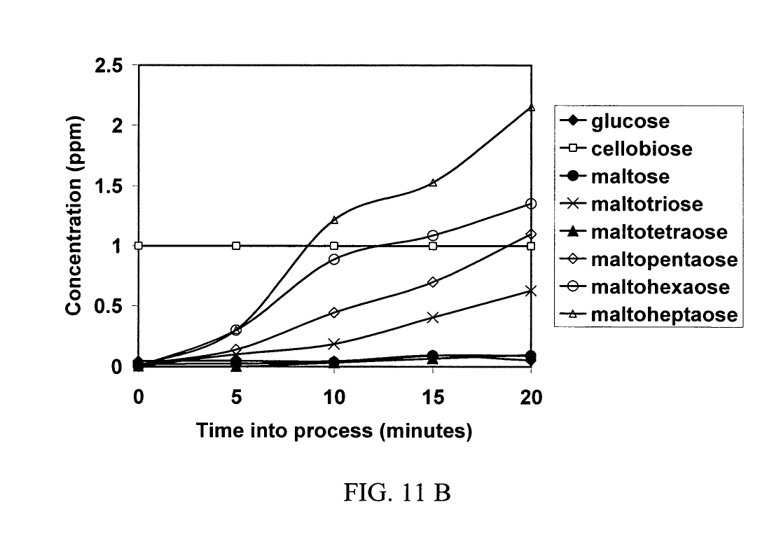

The chromatographic results from the EMPA 161 plus Bacillus sp. detergent process are shown in FIG. 11A, as well as graphical representations of concentration (ppm) vs. time (minutes) for the analytes of interest (FIG. 11B). Response factors were taken from an average of bracketing 1 ppm cellobiose. Again, increase in most of the maltooligosaccharides can be observed over time at 0 min, 0-5 min, 5-10 min, 10-15 min, 15-20 min. The actual concentrations in the detergent process were determined by the recovery of the I.S. and from the signal ratio of [I.S.]/[analyte] for standard solutions. The results for a set of experiments were normalized based on the signal of the I.S.

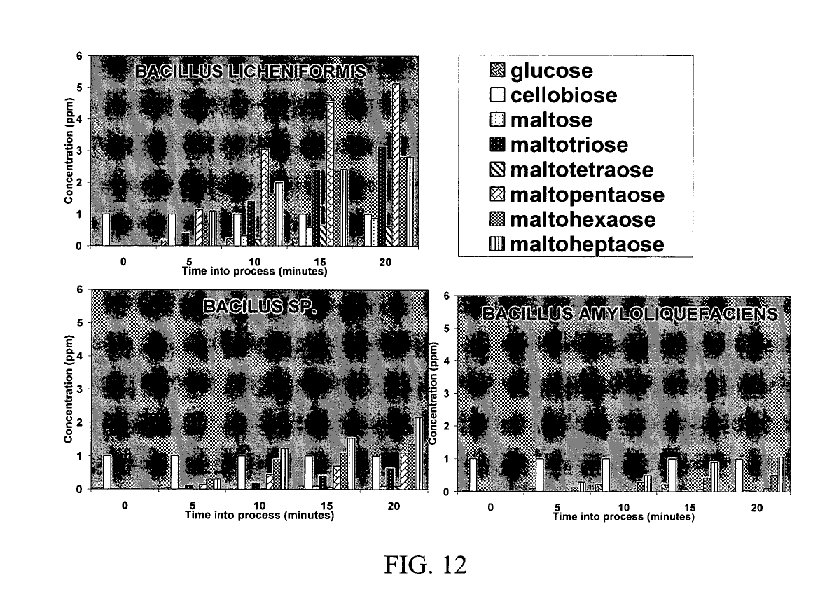

The M1-M7 profile of hydrolysis of EMPA 161 followed closely with the solution studies, as shown in the line graph comparisons of M1-M7 production during the two enzymatic processes. There are similarities in activity between the solution and cloth experiments; M3, M5, M6, and M7 are seen to increase for both sets of Bacillus sp. experiments. Note again that the rate of production in cloth detergent processes is much slower than in solution studies as seen by the scale of each graph—this is also reflected in the product profile. By looking at only the first 10 minutes of the Bacillus sp. solution studies, almost exactly the same profile is noted as the Bacillus sp. cloth studies. Thus, the progress of the reaction is simply slower in the cloth studies (perhaps due to binding of the starch to the cloth). The profiles of the other two enzymes are quite different from the Bacillus sp. The Bacillus amyloliquefaciens produces much less M3 and M5, slightly less M2 and M4, and also slightly more glucose (M1). Bacillus licheniformis activity shows much less M6 and M7 production relative to the other maltooligosaccharides. The comparison between EMPA cloth studies using the three detergent enzymes are shown in FIG. 12.

Similarly, the studies were carried out using 8 squares of Heinz Baby Food stained cloth and each of the three enzymes. It is not known how much starch was present on the Heinz Baby Food Cloth samples. The amount of glucose measured in these baby food cloth detergent processes was higher than the scale shown on the graphs (7-10 ppm) even before the addition of the enzyme, indicating that a large amount of this sugar is added to the baby food as a sweetener.

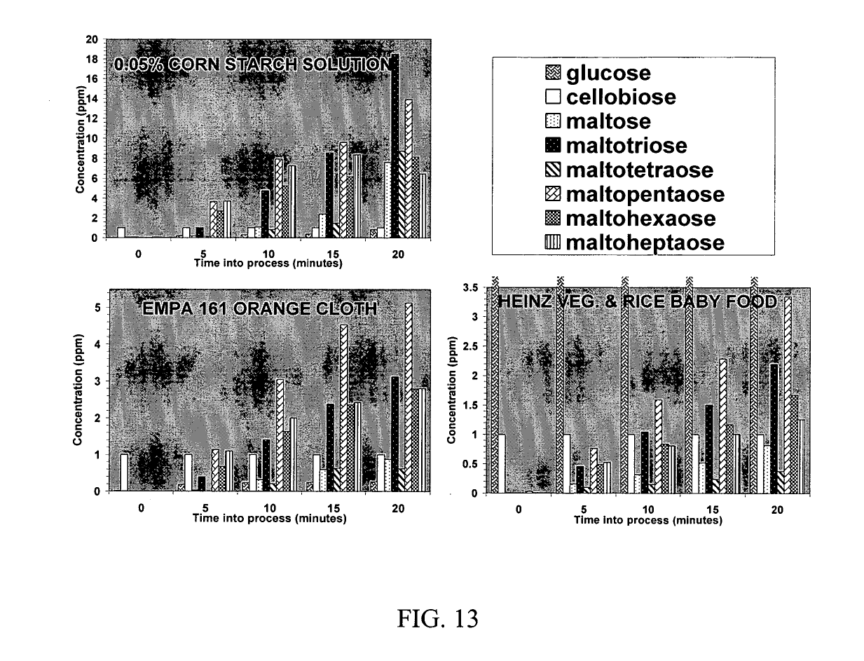

The M1-M7 profile of Bacillus licheniformis α-amylase hydrolysis of the baby food soiled cloth, which follows very closely with the EMPA 161 study and the solution study, can easily be observed in FIG. 13. Shown in this manner, the similarities in release profile are very clear; again, the same analytes (M3, M5, M6, and M7) are seen to increase with time for the three experiments. As expected, the rate of maltooligosaccharide production in cloth detergent processes is slower than in solution studies as seen by the concentration of M1-M7 produced. Surprisingly, the extent of breakdown in the baby food process is greater than in the EMPA studies. This may be a reflection of less starch on the EMPA cloths, a result of the manufacturing process that presses the starch into the fabric making it less accessible to the enzyme, or simply because it is a different starch and therefore hydrolyzed at a different rate (or some combination of these factors). What is interesting to note is that the profile of the hydrolysis is quite similar for three different substrates and the same enzyme. Conversely, the profiles of three enzymes hydrolyzing the same substrate are quite different. Thus, this method is not only useful for determining activity and comparing the effectiveness of enzymes in a detergent process; it can also be used as a fingerprinting tool for different enzymes with a set of analytes. It is envisioned that this may even be able to extend to other classes of enzymes (e.g. proteases).

### Example 2

### Fermentation Monitoring

Production of Ethanol from Natural Sources

An exemplary glucoamylase enzyme that is useful in the saccharification of corn mash for ethanol production is sold by Novozymes® (Franklinton, N.C.) under the name Spirizyme® Fuel. Glucoamylase hydrolyzes the 1,4- and 1,6-α linkages in liquefied starch substrates. During hydrolysis, the enzyme acts to remove glucose units from the non-reducing end of the substrate.

In these studies, a liquefied corn mash was used for fermentation and carbohydrate monitoring studies. Seven key carbohydrates in the fermentation were monitored: glucose (M1), maltose (M2), maltotriose (M3), maltotetraose (M4), maltopentaose (M5), maltohexaose (M6) and maltoheptaose (M7).

The liquefied fermentation was reported to be very high in analyte concentration, and sample dilution was expected. Therefore, assay development began with collection of microdialysate fractions followed by off-line sample dilution prior to HPAEC-PED analysis. On-line dilution is utilizes which further minimizes sample handling and propagation of error. The ruggedness and utility of this instrumental technique for sampling in complex matrices is shown over a 60 hour bioprocess.

Background Response

Reported analyte (M1-M7) concentrations in the liquefied corn mash were as high as 60 g/L (60,000 ppm). Therefore, it was anticipated that a dilution step would be necessary to be in the linear range of the detector. Microdialysis sampling of a liquefied corn mash sample was carried out using 3 cm polyacetonitrile (PAN) loop probes, and the probe was protected from large particles by use of a polypropylene screen described above. An overhead stirrer was used at a rate of 100 RPM to help diffusional transport across the membrane. The dialysate samples were collected at a perfusion flow rate of 5 μL/min.

As expected, the fermentation microdialysis samples yielded an enormous background response that overwhelmed the detector and made the response of the sugars immeasurable. This is even more apparent in microbore chromatography, which affords greater sensitivity and lower detection limits, but also reduces the upper limit of linearity as the analyte response is maximized.

Selection of Dilution Factor

In order to determine what on-line dilution step would be necessary, samples were collected in fractions and then diluted 1:100, 1:1,000, and 1:10,000 and analyzed by the same HPAEC-PED method. It was determined that the 1:10,000 solution reduced the background signal, and put the responses of M1-M7 in the linear range of the detector.

Changes to MD Sampling and Injection Volumes

During the mash studies, the 1:10,000 dilution was carried out in two steps (1:100 twice) and proved to be fairly time-consuming. In order to decrease the sample preparation time, the microdialysis probes were changed from a 3 cm loop size to a 4 mm brain probe. The sampling device was a standard pin-style probe with rigid concentric cannulae and the PAN dialysis membrane at the tip. The probe is designed for in vivo implantation in conjunction with an intracerebral guide cannula, but can also be devoted to in vitro work.

In addition to decreasing the microdialysis sampling area from 3 cm to 4 mm, the loop injection volume was reduced from 25 μL to 10 μL. Dilutions were tested at 1:500. The height responses for the analytes were very similar to the 1:10,000 diluted samples collected with the 3 cm loop probe and larger injection volume. The long-term value of this improvement, then, was a more easily achievable dilution factor that would help make on-line dilution more feasible. The second improvement was that a larger dynamic range was observed for M1-M7 using a smaller injection volume, and good linearity (charge measured in nC, R² represents linear regression fit) was observed from the LOD to the highest concentrations tested (10 ppm) for all analytes as demonstrated in Table IV. Therefore, later mash and glucoamylase experiments were carried out using the 4 mm PAN probes and a smaller injection volume.

TABLE V-1
Calibration curves for glucose, maltooligosaccharides, and
cellobiose.

| Peak | | Sensitivity | | LOD (ppm, |
|---|---|---|---|---|
| No. | Analyte | nC = a(ppm) + b | R² | nM) |
| 1 | Glucose | y = 45.443x + 2.0957 | 0.9992 | 0.01, 1 |
| 2 | Cellobiose | y = 27.076x + 2.3559 | 0.9996 | 0.01, 0.6 |
| 3 | Maltose | y = 21.712x − 0.2153 | 0.9998 | 0.02, 3 |
| 4 | Maltotriose | y = 10.485x + 0.8148 | 0.9993 | 0.05, 3 |
| 5 | Maltotetraose | y = 11.464x + 1.0183 | 0.9994 | 0.04, 4 |
| 6 | Maltopentaose | y = 11.236x + 1.4747 | 0.9986 | 0.04, 2 |
| 7 | Maltohexaose | y = 9.4295x + 1.8419 | 0.9948 | 0.04, 2 |
| 8 | Maltoheptaose | y = 8.0332x + 1.7561 | 0.9955 | 0.06, 2 |

LOD estimated as 3 * S/N from lowest injected concentration

Osmotic Effects

Microdialysis sampling was initially carried out at a perfusion flow rate of 2 μL/min, and dialysate was collected into vials in 30 minute increments. The expected volume was 60 μL/vial. However, less than half of the expected value was attained. Rinsing the probe and pocket and placing them in a beaker of water yielded the expected microdialysis volume. This sequence was repeated several times with the same results. A possible cause of the reduced volume is a difference in osmolarity between sample and perfusate rather than external plugging of the membrane. It was determined that rather than using the osmotic agent to adjust the volume, a higher microdialysis flow rate (5 μL/min) would be selected. At this higher flow rate, ample volumes were collected, enough to reproducibly dilute the samples as was necessary for the off-line sample preparation.

HPAEC-PED of Corn Mash Dialysate

Waveform Modifications

During liquefied corn mash microdialysate analysis, it was observed that even with the dilution procedure, response at the electrode surface decreased with each injection, presumably due to fouling species accumulating on the electrode that could not be cleaned by the standard quadruple-potential waveform. Therefore, a harsher waveform was investigated. Three modifications were made. First, by going to a higher oxidative cleaning potential (E3) from +0.6 V to +0.8 V for a longer duration, the fouling was less pronounced. This is due to the fact that at higher potentials, more surface oxide is formed. This higher potential cleaning step was used in the original three-step PAD waveform for carbohydrates, but was found to result in some loss of the gold surface, decreasing the lifetime of the electrode.

Secondly, going to a lower reactivation potential (E4) from −0.1 V to −0.8 V, the surface oxide formed in the previous step could be electrocatalytically reduced more quickly and more effectively. Lastly, it was observed that alternating between these two positive and negative potentials during the cleaning process was found to remove fouling species and greatly improve the reproducibility. This is effective because it is similar to applying three cleaning sequences that form and remove surface oxide, providing a clean surface at which the waveform can be repeatedly applied. The modified potentials and times are listed in Table V.

TABLE V
Modified carbohydrate PED waveform for fermentation analysis.

| TIME (s) | POTENTIAL (V) | INTEGRATION |
|---|---|---|
| 0.00 | +0.1 | |
| 0.20 | +0.1 | Begin |
| 0.40 | +0.1 | End |
| 0.41 | −2.0 | |
| 0.42 | −2.0 | |
| 0.43 | +0.8 | |
| 0.48 | +0.8 | |
| 0.49 | −0.8 | |
| 0.54 | −0.8 | |
| 0.55 | +0.8 | |
| 0.60 | +0.8 | |
| 0.61 | −0.8 | |
| 0.66 | −0.8 | |
| 0.67 | +0.8 | |
| 0.72 | +0.8 | |
| 0.73 | −0.8 | |
| 0.91 | −0.8 | |

When the modified waveform was applied to the mash, a decreasing response was no longer observed. The reproducibility for n measurements was greatly improved, with RSD values less than 5% by implementing the new waveform for mash analysis. Analytes M1-M7 were quantitated from the averaged response factors of bracketing standard solutions.

By instituting a stronger pulsed potential cleaning profile, a more aggressive cleaning of the electrode surface is provided such that reproducible, quantitative results can be achieved even in complex matrices.

Selection of Internal Standard

In order to achieve quantitation of the analytes of interest in these studies, six potential internal standards were tested. These compounds were tested because they were not expected to be present in the mash samples, not amenable to hydrolysis by the glucoamylase enzyme, and were expected to exhibit the similar characteristics under the separation conditions as the sample components as they are carbohydrates. The I.S. serves to correct for errors in sampling (microdialysis recovery) and sample preparation (dilution).

The first two potential internal standards, lactose and fructose were found to coelute with analytes of interest and so were not appropriate for the analysis. The third compound, sucralose (1,6-dichloro-1,6-dideoxy-β-D-fructofuranosyl-4-chloro-4-deoxy-α-D-galactopyranose), was found to be retained (k′=9.02). However, its response was much weaker than the analytes of interest due to fewer oxidizable hydroxyl functionalities, and its peak shape was poor.

It is known that glucose β-1,4 linkages are not amenable to hydrolysis by α-amylase enzymes. Therefore members of this series were investigated as potential internal standards. The separation was the same as in the detergent processes as the analytes of interest had not changed. Under these conditions, cellotriose was found to co-elute with maltose and therefore was not chosen for this analysis. Cellobiose and cellotetraose were both determined to be suitable internal standards for these experiments. As the studies used high concentrations (10,000 ppm) of internal standard, cellobiose was chosen as it is far less expensive than cellotetraose.

Quantitation

To test if the internal standard was able to correct for changes in recovery and allow for accurate quantitation in this new and complex matrix, several experiments were conducted. First, microdialysis was carried out on ca. 50 g sample of liquefied corn mash, and fractions of the dialysate were collected at a perfusion flow rate of 5 μL/min. This was carried out using a 10,000 ppm solution of cellobiose as the internal standard. This collected sample was then diluted 1:10,000 to be in the linear range of the detector.

To determine the actual or “true” starting concentrations of sugars in the liquefied corn mash, a simple experiment was planned. Ten mL of the mash was placed in a Falcon™ tube and centrifuged at a rate of 3,000 g for 15 minutes. The supernatant was filtered using 0.45 μm PTFE filters prior to HPAEC-PED analysis. Each sample was analyzed in triplicate. The actual and experimentally determined values of the diluted samples are compared in Table VI. The error between actual and experimental values varied depending on the analyte.

TABLE VI
Initial concentrations of M1-M7 in mash by direct injection of
filtered/diluted supernatant and by microdialysis clean-up
prior to HPAEC-PED.

| | Actual Injected | Experimental MD | |
|---|---|---|---|
| Analyte | Concentration (ppm) | Concentration (ppm) | \|t\|_{calc} |
| M1 | 0.68 ± 0.01 | 0.7 ± 0.1 | 0.3 |
| CB* | 0.0 | 1.0 | — |
| M2 | 0.92 ± 0.01 | 1.3 ± 0.2 | 3.3 |
| M3 | 2.69 ± 0.05 | 2.4 ± 0.1 | 4.5 |
| M4 | 0.72 ± 0.01 | 0.7 ± 0.1 | 0.3 |
| M5 | 1.41 ± 0.02 | 2.0 ± 0.3 | 3.4 |
| M6 | 2.58 ± 0.04 | 2.4 ± 0.4 | 0.8 |
| M7 | 0.61 ± 0.01 | 0.7 ± 0.1 | 1.6 |

*Internal Standard = cellobiose in perfusate

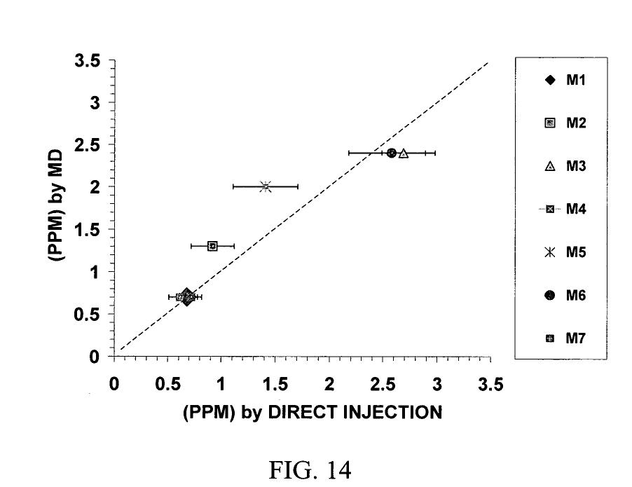

A correlation plot was constructed from the data in Table VI (see FIG. 14). The dashed line shows ideal behavior (slope=1) where the two methods would show a perfect correlation. As can be seen, several points deviate from ideal behavior.

In order to test whether the two means of M1-M7 as determined from the two methods are different, the t-test was employed. As there are 4 degrees of freedom for each analyte, the critical |t| value at the 99% confidence interval is 4.60. Thus, the difference between the two methods is not significant at the 0.1% level. The standard deviations for both methods show good reproducibility (larger s in MD measurements), without evidence of random error. However there appears to be a bias, or systematic error that affects the accuracy of the microdialysis method. Sources of error could include resistance to mass transport in the fermentation that can affect sampling, as well as sample collecting/handling procedures. As sample evaporation and errors in the two-step dilution process could affect the accuracy of the microdialysis method, on-line analysis provides a means to reduce these systematic errors and attain more accurate quantitation.

Spike and Recovery Experiments

In order to determine recovery values, the fermentation was spiked with 10,000 ppm of maltose. Fractions of the dialysate were again collected at the same rate, and diluted 1:10,000 prior to analysis. This effectively achieved an increase in concentration of M2 by 1.0 ppm after the sample had been diluted. The recovery of the internal standard was used to calculate concentration of M1-M7 present in the mash. In the spiked sample, recovery of maltose was 73%.

This recovery value indicates that either the internal standard was not serving to quantitate the analytes of interest, or that the recovery of the analytes in the solution was affected by resistance to mass transport. This relates back to Bungay's equation where:
EF=(C_{d}^{out}−Cⁱⁿ)/(C_{b}−Cⁱⁿ)=1−exp [−1/Q_{d}(R_{d}+Rₘ+Rₑₓₜ)]

EF is the dialysate extraction fraction and R_{d}, Rₘ and Rₑₓₜ are the resistances to diffusion due to the dialysate, the membrane, and the external solution, respectively. R_{d} and Rₘ are dependent on the properties of the membrane such as composition, pore size, membrane length, and area.

It is often assumed that Rₑₓₜ, which equals the solution resistance, is zero in a well-stirred solution. However, in this situation, where the stirring rate is restricted to 100 RPM by the ethanol manufacturers, and the mash is a complex matrix, the Rₑₓₜ can have a significant effect on the EF. In order to minimize the effect of solution resistance on recovery, very slow flow rates can be used to allow the analyte(s) more time to diffuse across the membrane. These slow flow rates can only be achieved by using on-line microdialysis, as evaporation and required transfer/dilution of solutions would hinder this when using off-line analyses.

Testing of Glucoamylase in Liquefied Corn Mash Fermentation

To ca. 100 g of the corn mash, Spirizyme® Fuel glucoamylase enzyme was added as a concentration of 0.45 anhydroglucose units/g dry solids, and incubation of the mash for fermentation was carried out at 32° C. (oven) while the solution was stirred at a rate of 100 RPM. Monitoring of sugar levels was carried out 2 times per hour for 8 hours. The microdialysate from these experiments was collected in thirty minute intervals and fractions were diluted 1:500 (20 μL to 10 mL) and analyzed by HPAEC-PED. Separation was carried out at 30° C.

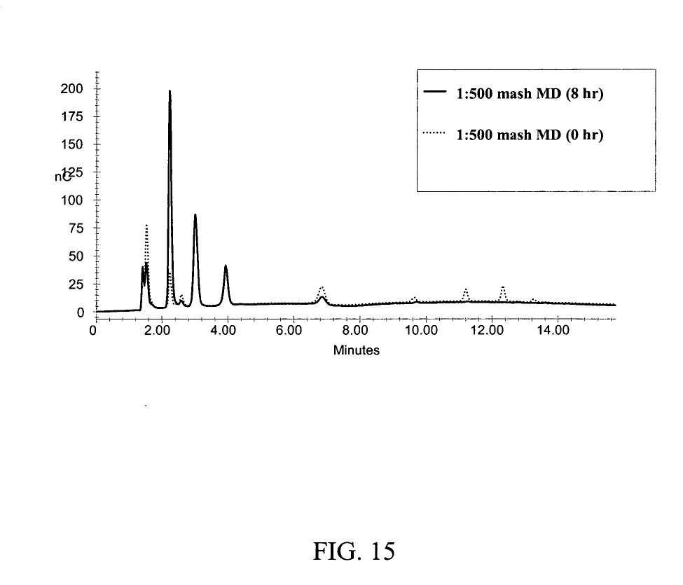

The hydrolysis products of glucoamylase plus mash were monitored during the course of fermentation processes. The dynamic changes could easily be monitored over the chosen time period. The height of the internal standard was used to determine percent recovery and to allow for accurate quantitation. The results for a set of experiments were normalized based on the signal of cellobiose. A before and after view is shown in FIG. 15, where chromatograms of t=0 hrs and t=8 hrs into the reaction are shown.

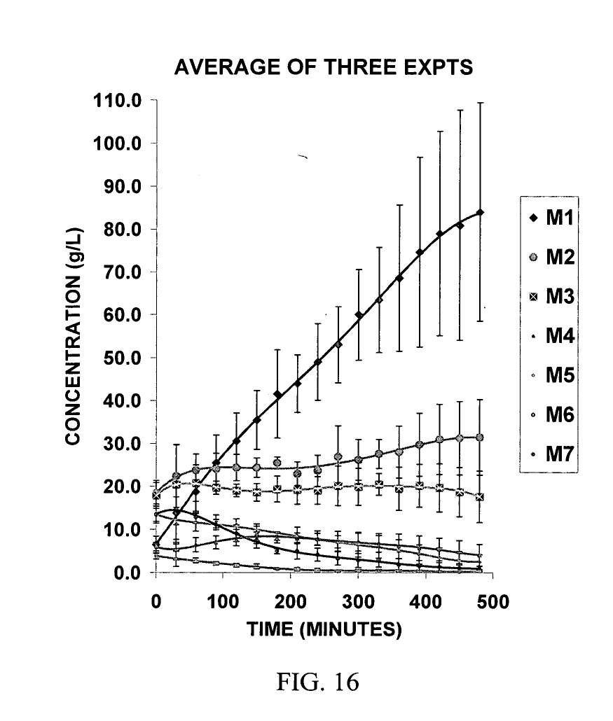

A 10 μL injection of 10 ppm standard mix and 0.25 ppm standard mix bracketed each set of three mash injections. Response factors were taken from an average of these standards. As expected, it was observed that the concentration of glucose (t_{R}=2.21) increased significantly, and the larger maltooligosaccharides (M3-M7) were hydrolyzed in the enzymatic process. The experiment was carried out in triplicate and the average concentrations of M1-M7 vs. time are listed in Table VII and depicted graphically in FIG. 16.

Note that the smooth curves connecting the points are not a prediction of experimental values, but are present only to facilitate the visualization of trends in the data. It is anticipated that with the addition of yeast to the liquefied corn mash, the amount of glucose will not reach the same magnitude as it will be consumed by the microorganisms for the production of ethanol in as industrial fermentation process. However, the focus of this work is on the activity and monitoring of the carbohydrate enzymes in the process and has not yet been extended to studying the activity of whole organisms.

TABLE V-5
[M1] to [M7] in glucoamylase and mash process by MD-HPAEC-PED.

| | [M1] | [M2] | | [M4] | [M5] | [M6] | |
|---|---|---|---|---|---|---|---|
| TIME (min) | (g/L) | (g/L) | [M3] (g/L) | (g/L) | (g/L) | (g/L) | [M7] (g/L) |
| 0 | 6 ± 2 | 18 ± 3 | 18 ± 3 | 6 ± 1 | 14 ± 2 | 13 ± 2 | 3.8 ± 0.7 |
| 30 | 14 ± 7 | 22 ± 7 | 20 ± 9 | 5 ± 2 | 11 ± 6 | 15 ± 8 | 3 ± 2 |
| 60 | 19 ± 5 | 24 ± 4 | 21 ± 4 | 6 ± 2 | 12 ± 2 | 13 ± 1 | 2.8 ± 0.5 |
| 90 | 25 ± 6 | 24 ± 4 | 20 ± 2 | 7 ± 1 | 12 ± 2 | 11 ± 1 | 2.1 ± 0.4 |
| 120 | 31 ± 7 | 24 ± 3 | 19 ± 1 | 8 ± 1 | 11 ± 1 | 9 ± 2 | 1.7 ± 0.4 |
| 150 | 35 ± 7 | 24 ± 2 | 19 ± 2 | 9 ± 2 | 9 ± 2 | 8 ± 2 | 1.4 ± 0.6 |
| 180 | 42 ± 10 | 25 ± 1 | 19 ± 3 | 8 ± 1 | 8 ± 1 | 5 ± 1 | 0.8 ± 0.1 |
| 210 | 44 ± 7 | 23 ± 3 | 19 ± 3 | 8 ± 1 | 9 ± 2 | 5 ± 2 | 0.8 ± 0.4 |
| 240 | 49 ± 9 | 24 ± 4 | 19 ± 3 | 8 ± 1 | 8 ± 2 | 4 ± 1 | 0.6 ± 0.5 |
| 270 | 53 ± 9 | 27 ± 7 | 20 ± 5 | 7 ± 1 | 7 ± 2 | 3 ± 2 | 0.3 ± 0.2 |
| 300 | 60 ± 11 | 26 ± 5 | 20 ± 4 | 7 ± 2 | 6 ± 3 | 3 ± 2 | 0.5 ± 0.3 |
| 330 | 63 ± 12 | 28 ± 3 | 20 ± 3 | 7 ± 2 | 6 ± 3 | 3 ± 2 | 0.6 ± 0.2 |
| 360 | 69 ± 17 | 28 ± 6 | 19 ± 5 | 6 ± 3 | 5 ± 3 | 2 ± 1 | 0.5 ± 0.2 |
| 390 | 75 ± 22 | 30 ± 7 | 20 ± 5 | 6 ± 3 | 4 ± 2 | 1 ± 1 | 0.3 ± 0.2 |
| 420 | 79 ± 24 | 31 ± 8 | 20 ± 6 | 5 ± 3 | 4 ± 2 | 1 ± 1 | 0.3 ± 0.1 |
| 450 | 81 ± 27 | 31 ± 9 | 19 ± 6 | 5 ± 3 | 3 ± 2 | 1 ± 1 | 0.2 ± 0.1 |
| 480 | 84 ± 25 | 31 ± 9 | 18 ± 6 | 4 ± 3 | 2 ± 2 | 1 ± 1 | 0.3 ± 0.2 |

On-Line Analysis of Fermentation Mash

The potential errors obtained from fraction collection are two-fold. The first error is obtained from sample evaporation that can occur during the collection procedure. The second error results from variability in sample dilution. In order to mitigate the effects of these potential sources of error that could effect accurate quantitation and also to utilize slow microdialysis flow rates to allow time for analyte diffusion, on-line dilution and analysis was investigated.

Testing of On-Line Dilution Process

Testing the feasibility of on-line dilution was carried out using two syringe pumps and controllers. Each BAS syringe pump was equipped with a 2.5 mL syringe. The first BAS syringe pump controller setting was set to deliver fluid at a rate of 10 μL/min. The second BAS syringe pump controller was varied to achieve flow rates of 0.25, 0.5, 2, 2.5, and 10 μL/min, respectively. The two streams of fluid were directed using FEP connective tubing of 120 μm I.D. and combined in a mixing tee. The expected dilution factors, then, are 41, 21, 6, 5, and 2. The outbound stream from the mixing tee was delivered using PEEK tubing of 0.03 inches (760 μm ID) in order to minimize backpressure.

Results of the experiments demonstrated that values obtained by injecting the mixed sample, and direct injections of standard solutions. The two give almost identical regression lines (y=17.53x+0.05) for experimental, and y=17.50x+0.50 for actual). Both R² values were greater than 0.999. These results indicate that effective sample dilution of microliter volumes can be achieved through the mixing tee.

For on-line dilution, the microdialysate is mixed with water before it enters the injection loop using a static mixing tee. In order to achieve effective dilution, very slow flow rates were chosen for the syringe pump that was to deliver MD perfusion fluid. This BAS syringe pump was equipped with a 500 μL syringe, and the controller setting was set to 0.2, resulting in a fluid delivery rate of 0.1 μL/min. This number is multiplied by the volume of the syringe (in mL) in order to obtain the rate, 0.1 μL/min. The KD scientific syringe pump was used to deliver the diluent (water) at a precise rate (10 μL/min) using either a 10 mL or 50 mL gastight syringe. Therefore, the effective dilution factor was 0.1 μL/10.1 μL, or 1:101. The two streams were mixed and directed to the inlet of the HPAEC injection valve to fill an injection loop. Previously, a 500-fold dilution was required using a 10 μL injection loop. Here, a 2 μL loop volume was selected in conjunction with a 1:101 dilution in order to achieve the same approximate analyte responses in the linear range of the detector.

Glucose solutions (in the absence of a microdialysis probe) were used to test the pumping system. A direct injection of a 1 ppm glucose solution was carried out six times, followed by six injections of a 1 ppm glucose solution delivered by mixing the two streams. The height responses of the two sets of numbers were 17.1±0.2 nC and 17.0±0.3 nC, showing that accurate and precise dilution was occurring from the action of the two syringe pumps.

Real-Time Fermentation Process Monitoring

A dilution factor of 1:101 as discussed above was used for fermentation monitoring, this time with a microdialysis probe in-line. A 5000 ppm solution of cellobiose was used as the perfusate. To ca. 100 g of the corn mash in a three-arm flask, Spirizyme Fuel glucoamylase enzyme was added as a concentration of 0.45 AGU/g dry solids, and incubation of the mash for fermentation was carried out at 32° C. (water bath) while the solution was stirred at a rate of 100 RPM using an overhead stirrer. Monitoring of sugar levels was carried out every 40 minutes over the time course of 60 hours. The dead volume of the system was measured and accounted for. From the time the enzyme was added, 30 minutes was given so that the dialysate could reach the injection loop and be analyzed by HPAEC-PED. Separation was carried out at 30° C. using the LC-25 oven for temperature regulation.

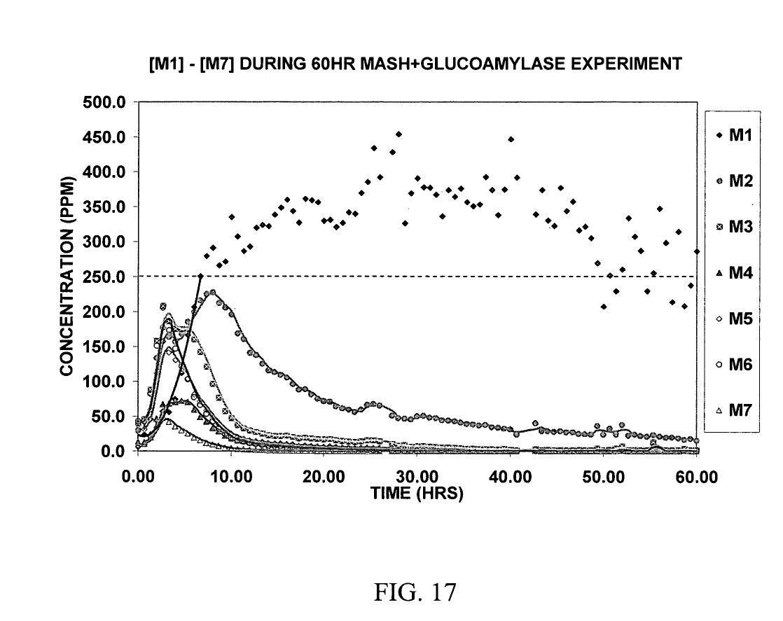

The results of the experiment are shown in FIG. 17. The experiment was bracketed by injecting 50 ppm standard mix before and after the run. The average of the response factors was used with the loss of the internal standard to calculate analyte concentrations. M1-M7 data were fit using a moving average with a period of 2. Maltooligosaccharides are shown to first grow, but then become depleted during the course of the enzymatic hydrolysis. It is surprising that these maltooligosaccharides are used up so quickly during the course of the fermentation. It is not clear whether this is due to limited supply of substrate (starch) in the mash, or because the substrate is bound in a fashion that the enzyme cannot readily access. Over the time course of the experiment, the growing response of glucose went past the limit of linearity (250 ppm), saturating the detector. Therefore, no trend line is drawn for these data points that are outside the linear range.

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

What is claimed is:

1. A method for on-line, real-time quantification of one or more analytes of an enzymatic reaction, comprising:
(a) transferring one or more analytes of an enzymatic reaction in a reaction vessel to a volume of perfusate, wherein the analytes are at an initial concentration in the reaction vessel;
(b) modulating the concentration of the one or more perfused analytes to a quantifiable concentration; and
(c) quantifying, in real-time, the one or more perfused analytes.

2. The method of claim 1, wherein the transferring comprises microdialysis sampling.

3. The method of claim 1, wherein the transferring comprises transferring one or more substrates of the enzymatic reaction.

4. The method of claim 1, wherein the transferring comprises transferring one or more products of the enzymatic reaction.

5. The method of claim 3, wherein at least one substrate is a carbohydrate.

6. The method of claim 4, wherein at least one product is a carbohydrate hydrolysis product.

7. The method of claim 1, wherein the perfusate is connected to the reaction vessel.

8. The method of claim 1, wherein the perfusate is indirectly connected to the reaction vessel.

9. The method of claim 1, wherein the modulating comprises flowing the perfusate at a measured flow rate, wherein the flow rate achieves a quantifiable concentration of the one or more perfused analytes.

10. The method of claim 9, wherein the flow rate of the perfusate is between about 100 nL/min and about 50 μL/min.

11. The method of claim 9, wherein the modulating further comprising diluting the one or more perfused analytes with a diluent.

12. The method of claim 1, wherein the modulating comprises flowing the perfusate at a flow rate that is less than about 100 nL/min, and diluting the one or more perfused analytes with a diluent, wherein the flow rate and the diluting achieve a quantifiable concentration of the one or more perfused analytes.

13. The method of claim 12, wherein the flow rate of the perfusate is less than about 50 nL/min.

14. The method of claim 1, further comprising introducing an internal standard into the enzymatic reaction and/or the perfusate prior to the quantifying.

15. The method of claim 1, wherein the quantifying comprises separating the one or more analytes, followed by detecting the one or more analytes.

16. The method of claim 15, wherein the separating is by liquid chromatography, size exclusion chromatography or anion exchange chromatography.

17. The method of claim 15, wherein the detecting is by ultraviolet absorption, fluorescence detection, mass spectrometry, refractive index detection or pulsed electrochemical detection.

18. The method of claim 15, wherein the detecting further comprises detecting an internal standard.

19. The method of claim 1, wherein the vessel comprises greater than about one liter of the enzymatic reaction.

20. A method for on-line, real-time quantification of one or more products and one or more substrates of an enzymatic reaction, comprising:
(a) transferring one or more substrates and one or more products in a reaction vessel to a perfusate with a microdialysis sampler, wherein the substrates and products are at an initial concentration in the reaction vessel;
(b) modulating the concentration of the one or more perfused substrates and one or more perfused products to a quantifiable concentration;
(c) separating the perfused substrates and the perfused products; and
(d) detecting, in real-time, the perfused substrates and the perfused products.

21. The method of claim 20, wherein the substrates are carbohydrates and the products are carbohydrate hydrolysis products.

22. The method of claim 20, wherein the perfusate is connected to the reaction vessel.

23. The method of claim 20, wherein the perfusate is indirectly connected to the reaction vessel.

24. The method of claim 20, wherein the modulating comprises flowing the perfusate at a measured flow rate, wherein the flow rate achieves a quantifiable concentration of the one or more perfused substrates and one or more perfused products.

25. The method of claim 24, wherein the flow rate of the perfusate is between about 100 nL/min and about 50 μL/min.

26. The method of claim 25, wherein the modulating further comprising diluting the one or more perfused substrates and one or more perfused products with a diluent.

27. The method of claim 20, wherein the modulating comprises flowing the perfusate at a flow rate that is less than about 100 nL/min, and diluting the one or more perfused substrates and one or more perfused products with a diluent, wherein the flow rate and the diluting achieve a quantifiable concentration of the one or more perfused substrates and one or more perfused products.

28. The method of claim 27, wherein the flow rate of the perfusate is less than about 50 nL/min.

29. The method of claim 20, further comprising introducing an internal standard into the enzymatic reaction and/or the perfusate prior to the quantifying.

30. The method of claim 20, wherein the separating is by liquid chromatography, size exclusion chromatography or anion exchange chromatography.

31. The method of claim 20, wherein the detecting is by ultraviolet absorption, fluorescence detection, mass spectrometry, refractive index detection or pulsed electrochemical detection.

32. The method of claim 20, wherein the detecting further comprises detecting an internal standard.

33. The method of claim 20, wherein the vessel comprises greater than about one liter of the enzymatic reaction.

34. An apparatus for on-line, real-time quantification of one or more analytes of an enzymatic reaction, comprising:
(a) a reaction vessel comprising greater than about one liter of the enzymatic reaction;
(b) a microdialysis sampler in fluid communication with the enzymatic reaction;
(c) a microdialysis sampler protective covering;
(d) a pump for regulating perfusate flow through the microdialysis sampler;
(e) a diluter;
(f) one or more separation devices;
(g) one or more detectors; and
(h) an automated controller.

35. The apparatus of claim 34, wherein at least one of the separation devices is a liquid chromatography device, a size exclusion chromatography device or an anion exchange chromatography device.

36. The apparatus of claim 34, wherein at least one of the detectors is an ultraviolet absorption detector, a fluorescence detector, a mass spectrometer, a refractive index detector or a pulsed electrochemical detector.
